(19) United States
(12) Patent Application Publication
(10) Pub. No.: US 2026/0288922 A1
(43) Pub. Date: Sep. 24, 2026

(54) DEEPRAWNET EMPOWERING DEEPFAKE AUDIO DETECTION THROUGH DYNAMIC ENHANCEMENTS

(71) Applicant: UNIVERSITY OF TABUK, Tabuk (SA)

(72) Inventors: Lubna Abdulaziz Aboalhassan ALHARBI, Tabuk (SA); Jasim Mohammed Ebrahim ALNAHAS, Tabuk (SA); Ali Javed Hussain QURESHI, Tabuk (SA); A’aeshah Abdullah Maqbool ALHAKAMY, Tabuk (SA); Marriam Nawaz Muhammad NAWAZ, Tabuk (SA); Hafiz Muhammad Aslam MALIK, Tabuk (SA); Hafsa Ilyas Muhammad ILYAS, Tabuk (SA); Faris Salem Salman ALFAIFI, Tabuk (SA)

(73) Assignee: UNIVERSITY OF TABUK, Tabuk (SA)

(21) Appl. No.: 19/084,619

(22) Filed: Mar. 19, 2025

(51) Int. Cl. G06F 21/32; G06N 3/044; G06N 3/048; G10L 17/18

(52) U.S. Cl. CPC G06F 21/32; G06N 3/044; G06N 3/048; G10L 17/18

(57) ABSTRACT

A method and a system for automatic speaker verification with detection of a voice cloning attack includes a voice cloning attack detection circuitry to detect the voice cloning attack based on a raw speech signal inputted at a speech receiving device. An authentication component authenticates a user based on the raw speech signal input. A backend operation server performs an operation (e.g., financial operation, accessing phones, controlling household appliances) based on the authentication of the user. A deep learning framework of the voice cloning attack detection circuitry comprises a convolutional block, a plurality of residual blocks and a gated recurrent unit (GRU). The convolutional block extracts features from the speech signal. A negative slope in fixed sinc filters in the residual blocks is increased to prevent dead neurons. The GRU aggregates a frame-level representation from a last of the residual blocks into an utterance-level representation.

### STATEMENT OF ACKNOWLEDGEMENT

Support provided by the Deanship of Research and Graduate Studies at University of Tabuk is gratefully acknowledged.

### BACKGROUND

### Technical Field

The present disclosure is directed to DeepRawNet: Empowering Deepfake Audio Detection through Dynamic Enhancements, and more particularly to a method and a system for automatic speaker verification with detection of a voice cloning attack.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Automatic speaker verification (ASV)-based systems are employed for authenticating an individual's identity based on their vocal characteristics. ASV systems have gained widespread application in various sectors, including fintech, surveillance, home automation, and security. The core functionality of ASV systems relies on the unique vocal features of an individual, such as pitch, tone, and speech patterns, to verify their identity. However, the generation of deepfake audio, which uses advanced machine learning algorithms to create highly realistic and convincing synthetic voices, poses a substantial threat to these systems.

Deepfake audio can mimic the vocal characteristics of legitimate users, making it increasingly difficult for ASV systems to distinguish between genuine and fraudulent voices. In fintech applications, deepfake audio attacks can compromise the security of voice-based authentication systems used in banking and financial services, leading to unauthorized transactions and significant financial losses. Fraudsters can gain access to electronic banking and financial services and conduct unauthorized financial transactions, transferring funds or making purchases without the account holder's consent. The financial impact on individuals and institutions can be substantial, as fraudulent transactions can lead to loss of funds, compensation claims, and erosion of trust in the security of voice-based systems. Similarly, in surveillance and security contexts, ASV systems that rely on voice recognition can be deceived by deepfake audio, allowing unauthorized individuals to gain access to secure areas or sensitive information. Attackers can use deepfake audio to impersonate authorized personnel, allowing them to gain unauthorized access to restricted areas or secure information. By tricking surveillance systems, malicious actors can intercept and access confidential communications, potentially leading to data breaches and the exposure of sensitive information.

Home automation systems that utilize voice commands are also vulnerable to deepfake audio attacks. Malicious actors can exploit these vulnerabilities to execute unauthorized actions, such as unlocking doors or disarming security systems, posing significant risks to personal safety and property. By mimicking the homeowner's voice, attackers can issue commands to smart home devices, such as unlocking doors, disarming security systems, or altering device settings. Unauthorized control of home automation systems poses significant risks, including potential break-ins, theft, and invasion of privacy. The safety and security of the household are compromised when malicious actors can manipulate smart devices using deepfake audio.

The primary types of deepfake audio attacks include speech synthesis, which generates artificial speech that mimics a specific individual's voice, and voice conversion (VC), which transforms one person's voice to sound like another's. These attacks undermine the integrity of ASV systems and can result in severe consequences, including data breaches, identity theft, and loss of trust in voice-based authentication technologies. The increasing prevalence of deepfake audio attacks necessitates the development of robust countermeasures to enhance the security and reliability of ASV systems.

Accordingly, it is one object of the present disclosure to provide methods and a system for automatic speaker verification with detection of a voice cloning attack to overcome the problems in the prior art.

### SUMMARY

In an exemplary embodiment an automatic speaker verification-based system with detection of a voice cloning attack is described. The system comprising a speech receiving device for inputting a raw speech signal. The system comprising a voice cloning attack detection circuitry configured to detect the voice cloning attack based on the raw speech signal inputted at the speech receiving device. The system comprising an authentication component for authenticating a user based on the raw speech signal inputted at the speech receiving device. The system comprising a backend operation server that performs an operation based on the authentication of the user. The voice cloning attack detection circuitry includes a deep learning framework having a convolutional block configured to extract features from the speech signal, a plurality of interconnected residual blocks, and a gated recurrent unit (GRU) configured to aggregate a frame-level representation from a last of the residual blocks into an utterance-level representation. A negative slope in fixed sinc filters in the residual blocks is increased to prevent dead neurons.

In an exemplary embodiment automatic speaker verification method is described. The method includes inputting a raw speech signal. The method includes detecting, by a voice cloning attack detection circuitry, a voice cloning attack based on the inputted speech signal. The method includes authenticating a user based on the raw speech signal inputted at the speech receiving device. The method includes performing, by a backend operation server, an operation based on the authentication of the user. The voice cloning attack detection circuitry includes a deep learning framework. The detecting includes extracting, by a convolutional block, features from the speech signal. The detecting includes increasing a negative slope in fixed sinc filters in multiple interconnected residual blocks to prevent dead neurons. The detecting includes aggregating, in a gated recurrent unit (GRU), a frame-level representation from a last of the residual blocks into an utterance-level representation.

In another exemplary embodiment, a non-transitory computer readable medium having instructions stored therein that, when executed by one or more processor, cause the one or more processors to perform a method of automatic speaker verification. The method comprising inputting a raw speech signal. The method comprising detecting, by a voice cloning attack detection circuitry, a voice cloning attack based on the inputted speech signal. The method comprising authenticating a user based on the raw speech signal inputted at the speech receiving device. The method comprising performing, by a backend operation server, an operation based on the authentication of the user. The detecting includes extracting, by a convolutional block, features from the speech signal. The detecting includes increasing a negative slope in fixed sinc filters in multiple interconnected residual blocks to prevent dead neurons. The detecting includes aggregating, in a gated recurrent unit (GRU), a frame-level representation from a last of the residual blocks into an utterance-level representation.

The foregoing general description of the illustrative embodiments and the following detailed description thereof are merely exemplary aspects of the teachings of this disclosure and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1A shows an exemplary scenario of audio deepfakes attacks.

FIG. 1B shows another exemplary scenario of audio deepfakes attacks.

FIG. 1C shows another exemplary scenario of audio deepfake attacks.

FIG. 2A shows an exemplary block diagram of an automatic speaker verification-based system, according to certain embodiments.

FIG. 2B shows an exemplary process flow of the automatic speaker verification-based system, according to certain embodiments.

FIG. 3A shows an operation flow of the conventional speaker verification system, according to certain embodiments.

FIG. 3B shows an operation flow of the automatic speaker verification-based system, according to certain embodiments.

FIG. 4 illustrates a flowchart of an automatic speaker verification method, according to certain embodiments.

FIG. 5 shows an illustration of a non-limiting example of details of computing hardware used in the computing system, according to certain embodiments.

FIG. 6 shows an exemplary schematic diagram of a data processing system used within the computing system, according to certain embodiments.

FIG. 7 shows an exemplary schematic diagram of a processor used with the computing system, according to certain embodiments.

FIG. 8 shows an illustration of a non-limiting example of distributed components which may share processing with the controller, according to certain embodiments.

### DETAILED DESCRIPTION

In the drawings, like reference numerals designate identical or corresponding parts throughout the several views. Further, as used herein, the words “a,” “an” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values therebetween.

Aspects of this disclosure are directed to a system and method for automatic speaker verification with detection of a voice cloning attack. The system incorporates a deep learning framework. The system detects audio deepfakes by processing raw audio. The system increases a negative slope in Fixed Sinc filters to prevent dead neurons. The system uses a Parametric Rectified Linear Unit (PreLU) activation function in the residual blocks instead of Leaky ReLU in the baseline in order to introduce a learnable negative slope to enhance adaptability and feature extraction. A convolution layer is substituted with a transpose convolution layer in the residual block to address downsampling issues while preserving fine-grained temporal information crucial for capturing complex patterns in raw audio. A LogSoftmax activation function provides stable and numerically efficient computations during training and inference, enhancing its performance for recognizing real and fake audio. This framework improves adaptability, robust learning capabilities, and enhanced capacity to capture sequential dependencies within raw audio waveforms, making the system a more effective solution for audio deepfake detection.

Automatic Speaker Verification (ASV) technology is used in biometric authentication, linking the unique vocal characteristics of individuals to authenticate their identity. The process involves creating a unique voiceprint or speaker model during enrollment, where the user's voice is recorded and securely stored in a database for later verification. The ASV analyzes the speaker's voice, including pitch, modulation, pace, and spectral features, to establish a comprehensive and distinct voice profile. The user's voice is initially captured to generate a reference voiceprint. Then, during the verification stage, the user provides their voice for comparison with the stored voiceprint. The ASV assesses the similarity between the presented voice sample and the enrolled voiceprint, using a predetermined threshold to make a decision. The verification is considered successful if the similarity score exceeds the threshold. In this way, the ASV enhances security measures. In access control, the ASV improves the conventional method by providing secure entry to restricted areas based on voice verification. Furthermore, in the financial sector, the ASV ensures secure authorization of transactions by allowing only authorized individuals to access sensitive financial information. Call centers integrate the ASV to authenticate users during customer service interactions, improving data security and preventing unauthorized access. The mobile devices incorporate the ASV for user authentication, enabling individuals to unlock their smartphones or perform secure transactions through spoken passphrases or specific commands. Additionally, the ASV plays a crucial role in forensic investigations, assisting in analyzing voice recordings for identification purposes. The ASV supports voice biometrics, facilitating identity verification systems in scenarios where secure and non-intrusive authentication is essential.

Currently, systems employing the ASV are increasingly challenged by the emergence of voice spoofing techniques, which aim to deceive the system's authentication processes. The ASV techniques introduce significant vulnerabilities, affecting ASV systems' reliability and compromising voice-based identification security. A physical voice spoofing method uses pre-recorded audio samples to mimic the targeted individual's voice, which makes ASV systems unable to discriminate between live and prerecorded voices, thereby risking the authentication of an imposter.

Due to publicly accessible voice recordings, attackers have abundant material for potential spoofing attempts, making physical voice spoofing a persistent threat. A Logical voice spoofing (audio deepfakes), i.e., voice conversion and voice synthesis, where voice conversion specifically involves altering the characteristics of a speaker's voice to match a predefined target, while voice synthesis utilizes advanced voice synthesis technology and deep learning algorithms to generate artificial voice samples that closely resemble the target's voice. The converted voice originates from a real person, which contains vigorous variations of the human voice, unlike speech synthesis without such variations, thus making voice conversion more challenging to detect.

Smart speakers (SS) (e.g., Amazon's Echo and Google Home) with built-in ASV technology are used in different application domains (e.g., home automation, online banking, forensics, etc.). The Smart speaker comprises microphones (e.g., Micro-electromechanical system (MEMS) microphones), speakers, power supplies (e.g., Switching regulators, digital power controllers, and power modules), voice assistants (e.g., virtual assistants), Bluetooth, Wi-Fi, touch controllers, radar, and display.

The use of ASV in SSs makes them unable to identify whether the given audio sample is real or synthetic. Hence, SSs are prone to a variety of audio spoofing attacks, including deepfakes.

The increased availability of AI tools and modern generative algorithms has made it easier to create convincing synthetic audio. Impostors can use this to spread disinformation campaigns, leading to political instability, chaos in financial markets, and more.

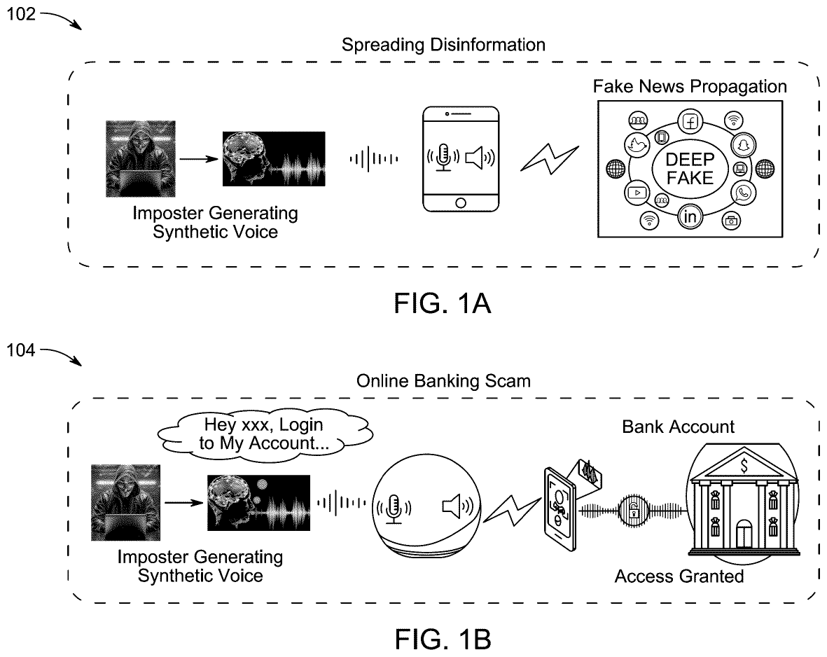

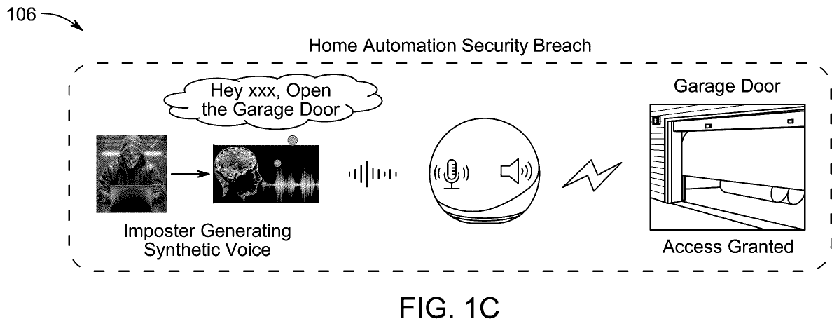

FIG. 1A shows an exemplary scenario 102 of audio deepfake attacks.

As shown in FIG. 1A, imposters generate synthetic voices and spread disinformation, which propagates fake news. To illustrate, imposters spread false or misleading information, often intending to manipulate public opinion or create confusion, using synthetic voices. Doing so, the imposters may create the illusion that a trustworthy or influential person is saying something they never actually said. Since synthetic voices sound convincing, listeners may be more likely to believe the information, making spreading fake news even more effective and dangerous. The use of synthetic voices by imposters allows them to fabricate realistic-sounding statements or news reports, contributing to the dissemination of disinformation and the potential manipulation of public perception.

FIG. 1B shows another exemplary scenario 104 of audio deepfake attacks.

As shown in FIG. 1B, audio deepfakes may be used through the system (e.g., smart speakers (SS)) to gain access to someone's online banking account, leading to financial scams. In a high-security environment, an attacker successfully gained access using a prerecorded audio sample of an authorized user's voice. By carefully crafting inputs (i.e., the user's voice) to match the decision-making patterns of the voice recognition system, the attacker tricked the system into approving unauthorized transactions.

This incident underscored the critical need to enhance the resilience of ASV (Automatic Speaker Verification) systems against sophisticated logical attacks to protect financial transactions and prevent fraudulent activities. The breach revealed the vulnerabilities in conventional access control measures and prompted a reassessment of security protocols. It highlighted the urgency of strengthening systems with more advanced voice recognition technology. The attackers exploited logical voice spoofing to deceive the ASV system during transaction authorizations, resulting in financial fraud.

FIG. 1C shows another exemplary scenario 106 of audio deepfakes attacks.

As shown in FIG. 1C, the imposter can create and play the deepfake voice of some individual to the system (e.g., the smart speaker (SS)) to breach the security of someone's home. Since the voice sounds identical to that of a trusted individual (such as the homeowner or a family member), the smart speaker may believe it's receiving an authorized command. The system might then execute commands, such as unlocking the door or disarming security features, allowing the imposter to access the home. This process highlights a vulnerability in voice-activated security systems. The imposter uses deepfake technology to impersonate trusted individuals and bypass security measures. To prevent such breaches, stronger safeguards and multi-factor authentication are needed in smart home technologies. Furthermore, incidents involving voice synthesis and conversion have demonstrated the potential for deception in diverse contexts. For instance, manipulated audio in the media, impersonating public figures or political leaders, underscores the broader societal implications of voice-based deception. Developing ASV systems that can effectively distinguish between genuine and synthetic voices is crucial for security applications and ensuring the integrity of communication channels across various domains.

Various techniques are designed to effectively recognize real and spoofed voices through the development of automated systems. One such technique, oriented around spectral feature analysis, detects voice spoofing by examining frequency components within the voice signal. However, this technique is vulnerable to advanced voice synthesis methods that precisely mimic natural spectral features. As attackers leverage sophisticated tools to generate artificially crafted voiceprints, distinguishing between genuine and synthetic voices based solely on spectral features becomes increasingly difficult. Moreover, spectral analysis alone struggles to capture subtle hints in manipulated voices, especially when attackers intentionally mimic the spectral characteristics of the target voice. The limitations of spectral feature analysis emphasize the need for more effective techniques to enhance the robustness of voice spoofing detection systems.

Machine Learning (ML) has proven to be a fundamental tool in the quest for effective voice spoofing detection. ML techniques, particularly supervised learning models, are trained on datasets containing genuine and spoofed voice samples, enabling the system to learn patterns and characteristics of spoofed voice indicative of deception. Relevant features (e.g., Mel-Frequency Cepstral Coefficients, or MFCCs) from the voice signal are extracted and fed into ML algorithms (e.g., Support Vector Machines, SVMs, or Random Forests, RF). These voice spoofing detection techniques identify the required patterns between authentic and manipulated voices, but they lack the scalability and generalization power necessary for more complex scenarios.

ML methods have shifted toward more sophisticated Deep Learning (DL) techniques. Deep neural networks (DNNs), such as Convolutional Neural Networks (CNNs) and Recurrent Neural Networks (RNNs), have excelled at learning hierarchical representations of voice data. DL models automatically extract complex features from the voice signal, enabling them to learn intricate characteristics indicative of voice spoofing. The ability of DNNs to adapt and generalize to diverse datasets enhances their effectiveness in handling evolving spoofing techniques.

However, audio spoofing detection still faces several challenges, such as the inability to distinguish between genuine and spoofed audio, as spoofing techniques are evolving and becoming increasingly sophisticated. Between the two categories of voice spoofing, detecting logical voice spoofing (synthesis and conversion) presents a unique set of challenges compared to recognizing physical voice spoofing. While physical voice spoofing involves the playback of pre-recorded audio, often exhibiting noticeable artifacts and microphone fingerprint traces, voice synthesis and conversion alter the characteristics of a person's voice dynamically without leaving microphone fingerprint traces.

In voice synthesis, entirely artificial voices are created, making it challenging to identify anomalies typically associated with replayed audio. Conversely, voice conversion transforms one person's voice into another seamlessly, maintaining the natural flow and pace. This makes voice conversion more challenging for detectors than voice synthesis. The absence of evident cues or artifacts, coupled with the potential for highly convincing output, makes the detection of synthesized or converted voices inherently more complex than physical voice spoofing. Attackers continually refine their approaches, utilizing advanced voice synthesis and conversion methods that mimic natural speech patterns with extraordinary accuracy. Traditional detection approaches, based on pattern recognition and anomaly detection, struggle to discriminate these dynamically altered voices, requiring advanced techniques that expand into the semantic and contextual aspects of speech for effective identification.

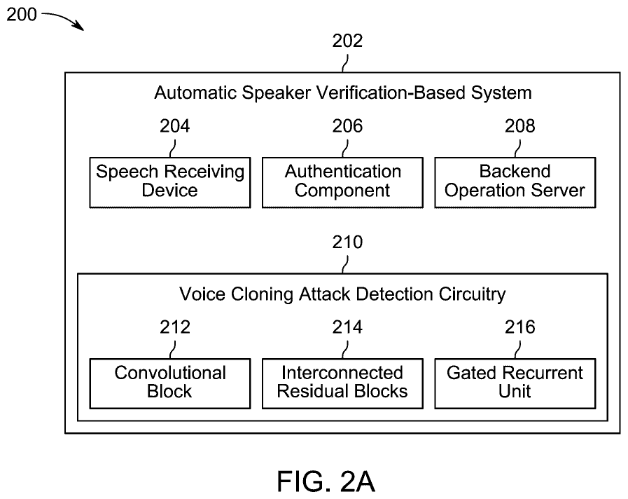

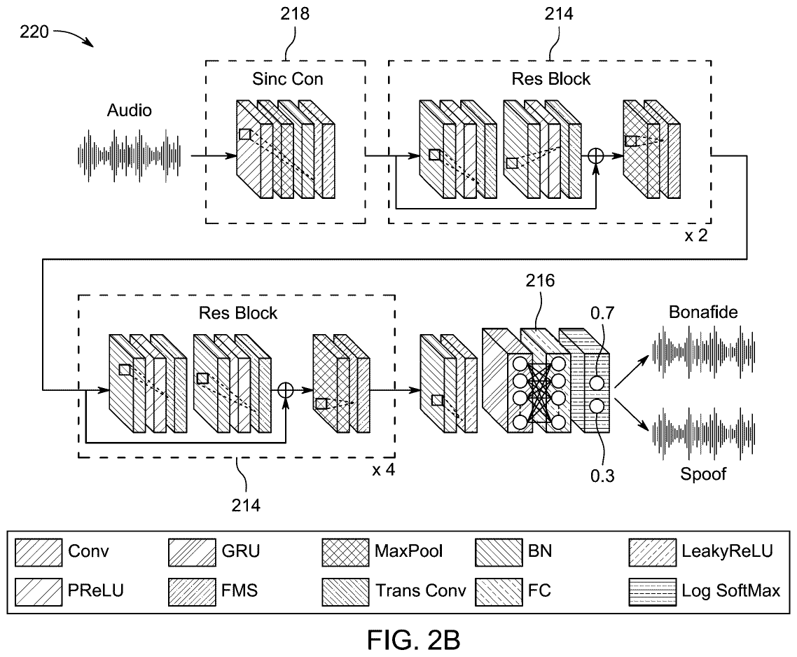

FIG. 2A shows an exemplary block diagram 200 of an automatic speaker verification-based system 202, according to certain embodiments. The automatic speaker verification-based system 202 comprises a speech receiving device 204, an authentication component 206, a backend operation server 208 and a voice cloning attack detection circuitry 210.

The speech receiving device 204 is configured to input a raw speech signal. In an aspect, the speech receiving device 204 is a mobile device or a smart speaker having voice assistant circuitry. Among other things, the speech receiving device 204 typically includes a microphone array and audio processing circuitry. In an operative aspect, the speech receiving device inputs a control command as the raw speech signal to request control of the household appliance.

The voice cloning attack detection circuitry 210 is configured to detect the voice cloning attack based on the raw speech signal inputted at the speech receiving device. The voice cloning attack detection circuitry 210 detects that the speech signal is generated by either speech synthesis or voice conversion. In an aspect, the speech synthesis refers to a process of converting text into spoken words. In an aspect, the voice conversion transforms one person's voice into another seamlessly, maintaining the natural flow and pace or alters characteristics of a speaker's voice to match a predefined target.

The voice cloning attack detection circuitry 210 includes a deep learning framework. The deep learning framework comprises a sinc convolutional filter block 212, a plurality of interconnected residual blocks 214, and a gated recurrent unit 216. The sinc convolutional filter block convolves the waveform with a set of parametrized sinc functions that implement band-pass filters. The sinc function is commonly defined as sin (x)/x.

The sinc convolutional filter block 212 is configured to extract features from the speech signal. In an aspect, the features from the speech signal comprise, but are not limited to, pitch, modulation, pace, spectral features, acoustic features, among others.

As will be described later, each of the interconnected residual blocks 214 comprises fixed sinc filters, a PreLU activation function and a transpose convolution layer.

A negative slope in fixed sinc filters in the residual blocks 214 is increased to prevent dead neurons. In training an artificial neural network, a “dead neuron” refers to a neuron that consistently outputs the same value (usually zero) regardless of the input it receives, effectively stopping it from contributing to the learning process. In an aspect, the fixed sinc filters are used to extract features from the speech signals to analyze the frequency content of the speech. These filters may remove or attenuate frequency components that are not useful for distinguishing between real and fake audio. The negative slope in fixed sinc filters refers to a characteristic of the frequency response of the filter. The negative slope in the filter attenuates higher frequencies more than the lower ones, creating a downward slope in the frequency response curve. Attenuating higher frequencies reduces noise or distortions in higher-frequency ranges. The lower frequencies comprise identity-related information (e.g., vocal tract, formants). In an aspect, the neurons are units that process input data and learn patterns. In an operative aspect, the neurons process the features extracted by the fixed sinc filters to learn the relationships between data points of the features. The dead neuron refers to a neuron whose output is always zero or never activates, regardless of the input it receives. It does not contribute to the learning process.

The negative slope ensures that even if the neurons receive small or negative inputs, they don't die (i.e., they remain active and participate in the learning process). This allows the network to better learn from the feature representation extracted by the fixed sinc filters.

In this way, the neurons are prevented from becoming entirely ineffective, facilitating the flow of gradients during backpropagation and enabling learning from all data points, including those with negative input values. More diverse features and representations are captured. This enhances the model's expressiveness. Further, the increased negative slope reduces gradient problem and benefits deep neural networks. In an operative aspect, a significant portion of the input values can be negative, the increased negative slope allows for more effective learning and improving the overall training dynamics.

The transpose convolution layer in the residual blocks 214 is used to preserve fine-grained temporal information. In an aspect, the transpose convolution layers in the residual blocks 214 preserve fine-grained temporal information which is used for capturing intricate patterns in deepfake audio data and temporal dependencies. The transpose convolution layers reduce downsampling issues.

In an aspect, the PReLU activation function in each residual block presents a learnable negative slope to mitigate the risk of dead neurons. The increased adaptability of PRELU enabled by its learnable parameters ensures dynamic responses to various input distributions, promoting more effective learning and feature extraction.

The gated recurrent unit (GRU) 216 is configured to aggregate a frame-level representation from a last of the residual blocks into an utterance-level representation. In an aspect, the GRU 216 comprises 1024 hidden nodes to consolidate frame-level representations into a unified utterance-level representation. An additional fully connected layer follows the GRU 216 output before reaching the output layer.

The voice cloning attack detection circuitry 210 includes a LogSoftmax activation function in a final layer of the deep learning framework for recognizing real and fake audio. The LogSoftmax activation function transforms raw model outputs into logarithmic probabilities of real or fake audio data. The logarithmic probabilities of real or fake audio data provide numerical precision (i.e., whether raw model outputs comprise more real data or fake data). Based on the logarithmic probabilities, the voice cloning attack detection circuitry 210 determines the raw speech signal is real or fake.

The authentication component 206 is configured to authenticate the user based on the raw speech signal inputted at the speech receiving device 204. In an aspect, if the voice cloning attack detection circuitry 210 determines the inputted raw speech signal is real user audio, the authentication component 206 authenticates the user. Further, if the voice cloning attack detection circuitry 210 determines the inputted raw speech signal is fake audio, the authentication component 206 does not authenticate and instead rejects the user.

The backend operation server 208 performs an operation based on the authentication of the user. The backend operation comprises, but is not limited to, access to phone operations, a financial operation that requires secure operation and control of a household appliance. In an aspect, if the user is authenticated by the authentication component 206, the backend operation server 208 performs the operation inputted by the user via the speech signal.

FIG. 2B shows an exemplary process flow 220 of the automatic speaker verification-based system 202, according to certain embodiments.

The framework 220 of the automatic speaker verification-based system 202 is a deep learning framework. The framework 220 of the system 202 comprises sinc convolutional (sinc con) block 218, the interconnected residual blocks 214, the GRU 216. The sinc con 218 comprises the sinc convolutional filter block 212, a maxpool layer, a batch normalization (BN) layer, and a leaky ReLU. A “sinc con” refers to a type of convolutional layer that uses a sinc function as its filter kernel.

The sinc convolutional filter layer 212 receives the raw speech signal from the speech receiving device. The sinc convolutional filter layer 212 extracts features from the raw speech signal.

The maxpool layer may receive the extracted features of the raw speech signal from the convolution layer. The maxpool layer may perform downsampling of the extracted features to create downsampled feature map. The BN layer may perform normalization to fix means and variances of each layer's inputs by re-centering and re-scaling.

The Leaky ReLU may introduce a small fixed negative slope for negative function inputs. The negative slope value of the Leaky ReLU in the Fixed Sinc filters can be increased before training. In an aspect, values of the negative slope parameter range from 0.1 to 0.6 (Note: slope value of 0.5 achieved the most optimal results). By introducing a small, non-zero negative slope in the Leaky ReLU, a small gradient is allowed for negative inputs. This helps to mitigate the issue of dead neurons and ensures that all neurons contribute to the learning process.

The interconnected residual blocks 214 comprise multiple blocks. The multiple blocks of the residual blocks 214 comprise the BN layer, a PreLU layer, and a transpose convolution layer.

The BN layer in the residual blocks 214 may further normalize signals outputted from the sinc con 218. The PRELU activation function in the residual blocks 214 is used instead of the Leaky ReLU to present a learnable negative slope which further mitigates the risk of dead neurons. A PRELU allows the slope for negative values to be learned during training as a parameter, while Leaky ReLU uses a fixed, predefined small slope for negative values. The PRELU ensures dynamic responses to various input distributions, promoting more effective learning and feature extraction. The negative slope in the Fixed Sinc filters in residual blocks 214 is increased to prevent dead neurons, which provides a more dynamic and effective representation of features across the entire input space. Further, the simple convolution layer is substituted with the transpose convolution layer in the residual block 214. This helps reduce downsampling issues and preserves fine-grained temporal information vital for capturing complicated patterns in raw audio.

The residual blocks 214 further comprise the maxpool layer and a feature map scaling (FMS). The maxpool layer allows further feature extraction and downsampling of the extracted features.

The framework 220 further comprises a final layer comprising the BN layer, the leaky ReLU, the GRU 216, FC, and LogSoftMax.

The BN layer in the final layer may further normalize signals outputted from the residual blocks 214.

The LogSoftmax activation function in the network's final layer helps recognize the real and fake audio. The LogSoftmax transforms the raw model outputs into logarithmic probabilities, facilitating more stable and numerically efficient computations during training and inference.

In this way, the automatic speaker verification-based system 202 provides an end-to-end deep learning (DL) framework to enhance the audio spoofing detection performance over the conventional method. The automatic speaker verification-based system 202 enhances adaptability, robust learning capabilities, generalization, and the ability to learn sequential dependencies within raw audio waveforms, making it a more effective solution for ASV and speech analysis.

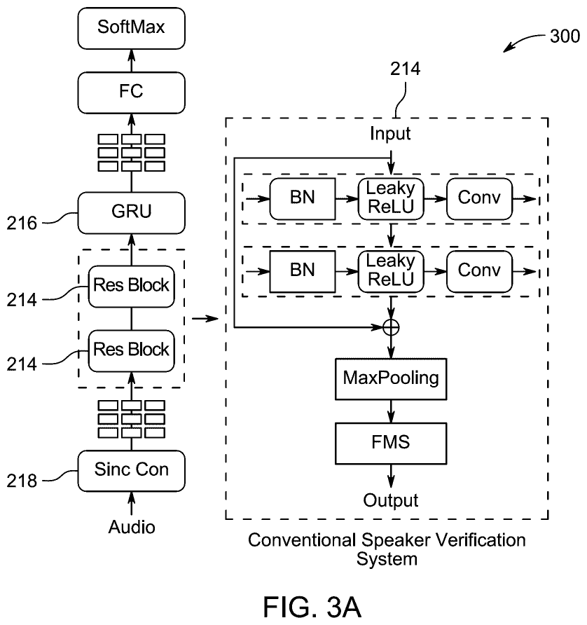

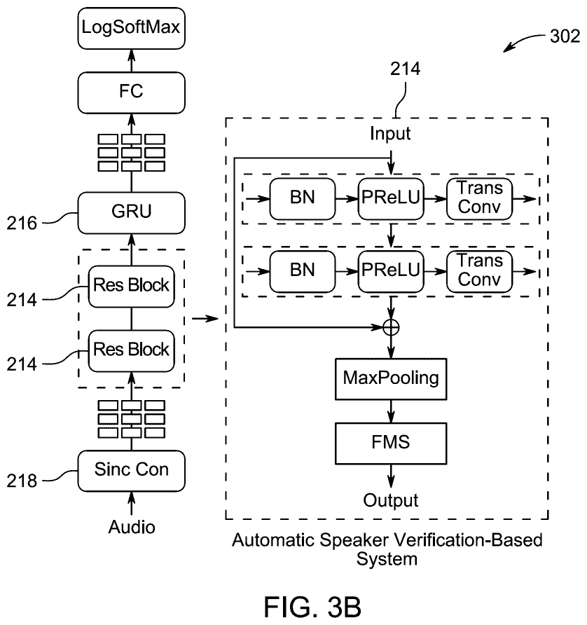

FIG. 3A shows an operation flow 300 of the conventional speaker verification system (RawNet2), according to certain embodiments.

The conventional speaker verification system comprises the sinc cons, the plurality of residual blocks, the gated recurrent unit (GRU), the fully connected (FC) layer, and the SoftMax. Further, it comprises the batch normalization (BN) layer, the Leaky ReLU, the convolution layer (Conv), the max pooling, and the feature map scaling (FMS).

The conventional speaker verification system (RawNet, RawNet2) processes raw audio waveforms directly without feature extraction methods (e.g., spectrograms or Mel-Frequency Cepstral Coefficients). Complex temporal patterns are captured in audio signals to provide a more direct and detailed representation of tasks (e.g., speech processing and speaker recognition). The conventional speaker verification system comprises convolutional layers for feature extraction, recurrent layers (e.g., Long Short-Term Memory) for capturing temporal dependencies, and fully connected layers for final predictions. The raw waveforms are used to learn hierarchical features from the audio for anti-spoofing. On the other hand, the conventional speaker verification system faces issues with computational efficiency, generalization, model parameters and overfitting due to its processing of raw waveforms, which requires the computation of a more relevant set of sample features.

Conventional speaker verification system uses Filter-wise Feature Map Scaling (FMS) in residual blocks which allows dynamic adjustment of feature map sizes. FMS is a process of adjusting the size of the feature maps produced by convolutional layers, typically by manipulating parameters like filter size, stride, and padding, to control the level of detail captured in the extracted features, while also managing the computational complexity of the network. This reduces model parameters, enhancing computational efficiency and improving generalization across diverse datasets. Additionally, the multiplicative FMS used in the conventional speaker verification system, similar to an attention mechanism, captures relevant information, which contributes to addressing limitations related to interpretability and the effectiveness of attention mechanisms.

The verification comprises steps such as extracting the input feature sequence from the frame-level representation by utilizing residual blocks. Subsequently, the GRU is used to aggregate the frame-level representation into an utterance-level representation to allow comprehensive sequence analysis and discrimination. The resultant representation is then passed through a fully connected layer. During the evaluation phase, the softmax activation function is applied after the fully connected layer to classify real or deepfake audios. The ReLU function sets all negative values to zero, which tends to result in dead neurons and potential information loss during training.

Table 1 shows structural comparison of conventional speaker verification system (RawNet and RawNet2).

TABLE 1
Architectural comparison of conventional speaker
verification systems (RawNet and RawNet2)

| RawNet | | | RawNet2 | | |
|---|---|---|---|---|---|
| Layer | Input | Output | Layer | Input | Output |
| Stride Con | Conv(3, 3, 128) | (19683, 128) | Sinc Con | Sinc(251, 1, 128) | 19683, 128 |
| | BN LeakyReLU | | | MaxPool(3) BN | |
| | | | | LeakyReLU | |
| Res block | {Conv(3, 1, 128) | (2187, 128) | Res block | {BN LeakyReLU | (2187, 128) |
| | BN LeakyReLU | | | Conv(3, 1, 128) | |
| | Conv(3, 1, 128) | | | BN LeakyReLU | |
| | BN LeakyReLU | | | Conv(3, 1, 128) | |
| | MaxPool(3)} × 2 | | | MaxPool(3) | |
| | | | | FMS} × 2 | |
| Res block | {Conv(3, 1, 256) | (27, 256) | Res block | {BN LeakyReLU | (27, 256) |
| | BNLeakyReLU | | | Conv(3, 1, 256) | |
| | Conv(3, 1, 156) | | | BN LeakyReLU | |
| | BN LeakyReLU | | | Conv(3, 1, 256) | |
| | MaxPool(3)} × 4 | | | MaxPool(3) | |
| | | | | FMS} × 4 | |
| GRU | 1024 | (1024,) | GRU | 1024 | (1024,) |
| Speaker | 128 | (128,) | Speaker | 1024 | (1024,) |
| embedding | | | embedding | | |

The residual block in the baseline model serves as a foundational component in the network architecture, crucial for processing raw audio waveforms effectively. The residual block comprises a skip connection and a main processing path. The residual block enables the extraction of complex features by combining information from both paths. This helps overcome the vanishing gradient problem which is a challenge in training deep neural networks. The skip connection facilitates the smooth flow of gradients, effectively training deeper architectures without degradation issues. However, the use of LeakyReLU in the residual block can lead to the issue of dead neurons. In LeakyReLU, the negative slope is fixed, typically at a small constant value. As a result, the gradient is scaled by a constant factor for all negative inputs, preventing complete neuron inactivity as seen in ReLU. However, this can cause suboptimal learning dynamics. The fixed negative slope in LeakyReLU may not be well-suited to capture the patterns present in raw audio data. Some neurons remain relatively inactive throughout training, particularly if the data distribution requires a more flexible adjustment of the negative slope. This leads to a partial loss of representational capacity, hindering the system's ability to effectively learn discriminative features from raw audio waveforms.

The use of convolutional layers involves pooling operations to downsample the input, which may reduce the temporal resolution of the features. In pooling (i.e., downsampling) operations, fine temporal details are potentially lost in tasks involving sequential data, such as speech processing.

FIG. 3B shows an operation flow 302 of the automatic speaker verification-based system 202, according to certain embodiments.

The automatic speaker verification-based system 202 comprises the Sinc convolutional (Sinc cons) block 218, the interconnected residual blocks 214, the gated recurrent unit (GRU) 216, the fully connected (FC) layer, and the LogSoftMax. Further, the residual blocks 214 of the automatic speaker verification-based system 202 comprises the batch normalization (BN) layer, the PRELU, the transpose convolution layer (Trans Conv), the max pooling, and the feature map scaling (FMS).

In the automatic speaker verification-based system 202, the Sinc con 218 receives audio (i.e., raw speech signal) from the speech receiving device 204. In the Sinc con 218, frequency information is extracted from the audio. The extracted frequency information is downsampled to create downsample feature map. The negative slope value of the LeakyReLU in the Fixed Sinc filters is increased from the original small slope.

In an aspect, the negative slope in Leaky ReLU is increased in order to address one of the limitations inherent in traditional ReLU activation functions. By introducing a small, non-zero negative slope in Leaky ReLU by a parameter (e.g., alpha), the activation function allows a small gradient for negative inputs. This modification mitigates the issue of dead neurons and ensures that all neurons contribute to the learning process. Further, after testing values of the negative slope parameter ranges from 0.1 to 0.6. For optimal results, the slope value is of 0.5. The increased negative slope in the Leaky ReLU prevents neurons from becoming entirely ineffective, facilitating the flow of gradients during backpropagation and enabling the model to learn from all data points, including those with negative input values. This helps capture more diverse features and representations, enhancing the model's expressiveness. Further, the increased negative slope reduces the gradient problem in the deep neural network. In an operative aspect, a significant portion of the input values may be negative. The increased negative slope allows for more effective learning and improves the overall training dynamics.

Further, the model of FIG. 3B makes two modifications within the residual block of the conventional model to prevent the occurrence of dead neurons.

The first modification includes the use of the PRELU with a learnable parameter for the negative slope. The PReLU's adaptability allows the disclosed model to learn the optimal negative slope during training, ensuring prevention of the occurrence of dead neurons and ensuring a more dynamic and effective utilization of neurons across the entire input range. Using the PRELU improves learning capabilities in scenarios where a fixed slope is suboptimal for capturing the complexity of raw audio features.

The second modification includes replacing the simple convolution layer in the residual block with the transpose convolution layer. A transposed convolutional layer (also referred to as deconvolution or fractionally stridden convolution layers) is an upsampling layer that generates an output feature map that is greater than the input feature map. This prevents issues related to downsampling and the loss of fine-grained temporal information.

Preserving the fine-grained temporal information in the raw audio waveforms is essential for capturing effective patterns and temporal dependencies. By incorporating the transpose convolution layers, the disclosed model upsamples the features and counteracts the downsampling effects introduced by standard convolution layers. Further, the transpose convolution layers help in the reconstruction of higher-resolution feature maps, allowing the model to retain more detailed temporal information and better capture the sequential dependencies present in the raw audio signals.

Further, GRU layer 216, comprising 1024 hidden nodes, consolidates frame-level representations into a unified utterance-level representation. An additional fully connected layer follows the GRU output before reaching the output layer.

Subsequently, the LogSoftmax activation function is used instead of the Softmax function to yield two-class predictions. This enables the separation of bonafide and spoof classes. The LogSoftmax is advantageous for tasks in raw audio processing within deep learning applications due to its ability to enhance numerical stability by working within the logarithmic space. This mitigates challenges associated with numerical precision during probability calculations, especially when dealing with raw audio data.

In an aspect, the LogSoftmax streamlines computational efficiency by consolidating exponentiation and normalization, simplifying gradient computations during backpropagation, and offering a more efficient processing approach. The LogSoftmax output (i.e., log probabilities) improves the model's prediction confidence during the complex raw audio processing. The LogSoftmax function reduces the risk of numerical underflow or overflow in a more steadfast and reliable probability estimation process than the Softmax. The LogSoftmax function is useful in raw audio processing, where precision in probability calculations and computational efficiency are paramount considerations.

In an aspect, the deep learning network may train with Adaptive Moment Estimation (ADAM) optimization using a learning rate of 0.0001 and weight decay of 0.0001, spanning 100 epochs, and employing a mini-batch size of 32.

### Experimental Results

Multiple experiments were conducted to evaluate the performance of the automatic speaker verification-based system model in audio spoofing/deepfakes detection. The datasets used in the experiments included the collection of speech recordings. All experiments were executed using samples from standard benchmark datasets (i.e., ASVSpoof-2019 and ASVSpoof-2021). The ASVSpoof-2019 may refer to Automatic Speaker Verification Spoofing and Countermeasures Challenge which is a collection of spoof data focused on developing systems that can detect both logical access (LA) and physical access (PA) spoofing attacks. The LA attacks are digital in nature and typically use synthetic speech, voice conversion, or text-to-speech (TTS) technologies to impersonate a target speaker. The PA attacks involve replaying pre-recorded speech in a physical environment to fool a microphone or ASV system. The spoof dataset includes a wide range of spoofing scenarios, including high-quality speech synthesis and advanced replay attacks. The dataset is intended to cover diverse spoofing methods and environments, providing a robust basis for training and evaluating anti-spoofing systems. The ASVSpoof-2021 is a dataset built on the ASVSpoof-2019 by expanding the scope to more realistic scenarios and introducing new categories of spoofing attacks including deep fake (DF) detections. The ASVSpoof-2021 dataset includes higher diversity in both LA and PA attack conditions and adds the new DF dataset to reflect the latest challenges in audio deepfake detection. The challenges encourage development of generalizable solutions that can handle evolving spoofing methods.

The ASVspoof-2019 serves as a comprehensive benchmark dataset to evaluate the efficacy of the automatic speaker verification-based system when opposed to various spoofing attacks. The ASVspoof-2019 comprises a diverse collection of speech recordings. The dataset contains genuine utterances and a spectrum of spoofing techniques (e.g., replayed speech, voice conversion, and speech synthesis). Through a balanced distribution of genuine and spoofed samples across different attack scenarios, ASVspoof-2019 ensures a thorough evaluation of ASV systems under realistic conditions. The ASVspoof-2019 can be used for effective detection and mitigation of the risks of spoofing attacks in real-world scenarios. For model evaluation, the ASVspoof-2019 logical access (ASV2019-LA) dataset is used to evaluate ASV systems in logical access scenarios.

ASVspoof-2021 is also a benchmark dataset for evaluating ASV systems' performance against spoofing attacks. It includes replay, voice conversion, and synthesis techniques. The dataset provides a comprehensive evaluation platform with standardized protocols, facilitating fair comparison and benchmarking of the ASV technologies.

The samples ASV2021-LA (logical access) and ASV2021-DF (deepfake) are used to evaluate the performance of the automatic speaker verification-based system. ASV2021-LA and ASV2021-DF are subsets of the ASVspoof-2021 dataset designed for specific evaluation scenarios. ASV2021-LA focuses on spoofing attacks relevant to logical access scenarios with codec and transmission channel variability. It offers a balanced distribution of genuine and spoofed speech samples across various conditions, enabling rigorous evaluation of the automatic speaker verification-based system's robustness in logical access settings. ASV2021-DF emphasizes deepfake attacks, in which speech is artificially generated using advanced synthesis techniques and contains compressed audio. This subset challenges the automatic speaker verification-based system to detect increasingly sophisticated spoofing attempts, contributing to advancements in anti-spoofing technologies.

The efficacy of the audio deepfake detection system is assessed using two key evaluation metrics (e.g., minimum Tandem Detection Cost Function (min t-DCF) and Equal Error Rate (EER)). The Min-t-DCF offers a comprehensive evaluation by assessing a tandem system while isolating the countermeasure (CM) and ASV systems. The EER represents the point where the false rejection rate (FRR) and false acceptance rate (FAR) are equal, providing a balanced performance measure.

To evaluate the performance of the disclosed model, two different experiments can be performed utilizing ASVspoof2019 and ASVspoof2021 datasets. The model is trained utilizing the train set of the ASV2019-LA dataset as training data and the development set as the validation data. While for testing, use the ASV2019-LA, ASV2021-LA, and ASV2021-DF datasets. Further, evaluation on the ASV2021-LA and DF datasets while being trained on the ASV2019-LA dataset assists in assessing the generalization capability and cross-dataset performance of the disclosed model. By evaluating the model's performance on the ASV2021-LA and ASV2021-DF datasets, which are distinct from the training dataset (ASV2019-LA), the evaluation determines how well the model performs on unseen data and its ability to detect spoofing attacks in different contexts. The results of both experiments are reported in Table 2. The reported results in Table 2 show that the approach attains effective results over both datasets. For the ASV2019-LA dataset, we have attained min-tDCF and EER of 0.1275 and 2.80, while for the ASV2021-LA dataset, min-tDCF and EER of 0.3666 and 7.77% are reported. Further, for the ASV2021-DF data sample, the approach has acquired an EER of 20.72%. It is quite evident from the results reported on both datasets that the disclosed approach shows effective audio-spoofing detection performance, which indicates the high recall and generalization power of the method. Moreover, it has been found from the reported values that the method attained better performance for the LA samples because of the complexity of DF samples, which involves compression attacks resulting in higher EER than the LA sets.

TABLE 2
Performance evaluation of Automatic Speaker
Verification-Based System (202) Model.

| Test Dataset | min_tDCF | EER (%) |
|---|---|---|
| ASV19-LA - Eval Set | 0.1275 | 2.80 |
| ASV21-LA - Eval Set | 0.3666 | 7.77 |
| ASV21-DF - Eval Set | — | 20.72 |

To perform an algorithm-wise Model Evaluation of the disclosed model, an experiment was conducted on the ASVspoof2019-LA eval dataset. ASVspoof2019-LA eval set contains the spoofed audios generated using different unknown attacks (A07 to A19). By conducting this experiment, the model's ability is evaluated to detect and classify spoofed audios generated by specific attacks within the ASV19-LA dataset. The results provide insights into how effectively the model can generalize and detect spoofing attacks it has not encountered during training. This experiment allows assess the model's robustness in detecting spoofed audio samples generated by various unknown attack algorithms, contributing to a comprehensive understanding of its performance in real-world scenarios. Three evaluation metrics, namely EER, min-tDCF, and accuracy, are computed, and the attained results are provided in Table 3. The evaluation across various unidentified attack techniques (A07 to A19) in the ASV19-LA dataset yielded promising results, showcasing the effectiveness of the approach in detecting a wide range of spoofing techniques. A little performance degradation has been witnessed for A17 and A18 attacks, as these contain VC samples, which are difficult to locate due to their high realism. By directly processing raw waveforms and leveraging advanced techniques such as feature map scaling and improved activation functions, our model can effectively extract and represent the related patterns and characteristics present in spoofed audio samples. These results highlight the robustness of the model, demonstrating its ability to accurately identify spoofed audio samples generated using different attack algorithms.

TABLE 3
Results on specific unseen attacks in evaluation
set of ASVspoof2019-LA Dataset.

| Attacks | Accuracy (%) | EER (%) | min_tDCF |
|---|---|---|---|
| A07 | 98.95 | 0.22 | 0.0538 |
| A08 | 97.11 | 3.24 | 0.1232 |
| A09 | 98.95 | 0.11 | 0.1831 |
| A10 | 98.81 | 0.42 | 0.0609 |
| A11 | 98.90 | 0.38 | 0.0588 |
| A12 | 98.92 | 0.42 | 0.0614 |
| A13 | 98.95 | 0.11 | 0.0519 |
| A14 | 98.95 | 0.23 | 0.0536 |
| A15 | 98.94 | 0.27 | 0.0560 |
| A16 | 98.86 | 0.63 | 0.0645 |
| A17 | 89.04 | 7.33 | 0.7333 |
| A18 | 72.20 | 16.46 | 0.8376 |
| A19 | 98.59 | 1.37 | 0.1295 |

Three comparison experiments were conducted to assess the disclosed model's performance against the existing ASVspoof baseline models (i.e., Rawnet2, LFCC-LCNN, LFCC-GMM, and CQCC-GMM). The comparison experiments were performed to compare the disclosed model's performance with the baseline models utilizing the ASVspoof2019-LA, ASVspoof2021-LA, and ASVspoof2021-DF datasets.

In the first experiment, the performance of the disclosed model is compared with baseline models on the ASV2021-DF Eval set to focus on the metric of EER. This comparison helps benchmark the disclosed model's efficacy against existing approaches in deepfake detection. This comparative analysis enables determining whether the disclosed model exhibits superior detection capabilities for deepfake speech samples, thus validating its effectiveness and potential practical utility.

Each baseline model represents a distinct approach to deepfake detection, ranging from traditional feature-based methods like LFCC and CQCC coupled GMM to more recent deep learning-based architectures like the conventional RawNet2 approach. A comprehensive assessment of efficacy in detecting deepfake audio is obtained by comparing the disclosed model's performance against these established baselines. The comparison is shown in Table 4. The scores in Table 4 show that the disclosed approach attains the lowest EER with a value of 20.72% over the ASVspoof-2021-DF dataset, which indicates the effectiveness of the disclosed approach.

TABLE 4
Comparison with baseline models utilizing
the ASVspoof-2021-DF dataset.

| Model | Test Dataset | EER (%) |
|---|---|---|
| Baseline - LFCC-LCNN | ASV2021 - | 23.48 |
| Baseline - LFCC-GMM | DF - Eval | 25.25 |
| Baseline - CQCC-GMM | Set | 25.56 |
| Baseline - RawNet2 | | 22.38 |
| Automatic Speaker Verification-Based | | 20.72 |
| System (202) Model | | |

In a second experiment, the results of the disclosed approach on the ASVspoof 2021-LA dataset were compared with the baseline approaches. The min_tDCF and EER evaluation measures were computed. The obtained measures are shown in Table 5. The reported results in Table 5 show that the disclosed approach outperforms the baseline approaches for both evaluation measures. The baseline LFCC-GMM approach attains the lowest results with the min_tDCF and EER scores of 0.5758 and 19.30%, respectively. The LFCC-LCNN approach shows the comparative results with the min_tDCF and EER scores of 0.3445 and 9.26%. In contrast, the disclosed model shows a significant improvement in audio deepfakes detection with the min_tDCF and EER scores of 0.3666 and 7.77% which clearly shows the robustness of the disclosed approach.

TABLE 5
Comparison with baseline models utilizing
the ASVspoof2021-LA dataset.

| Model | Test Dataset | min_tDCF | EER (%) |
|---|---|---|---|
| Baseline - LFCC- | ASV2021 - | 0.3445 | 9.26 |
| LCNN | LA - Eval | | |
| Baseline - LFCC- | Set | 0.5758 | 19.30 |
| GMM | | | |
| Baseline - CQCC- | | 0.4974 | 15.62 |
| GMM | | | |
| Baseline - RawNet2 | | 0.4257 | 9.50 |
| Automatic Speaker | | 0.3666 | 7.77 |
| Verification-Based | | | |
| System (202) Model | | | |

The results reported in Table 4 and Table 5 show that the disclosed approach performs well for LA and DF samples from the ASVspoof-2021 dataset. The LA and DF tasks from the ASVspoof-2021 dataset contain bona fide and spoofed utterances generated using text-to speech (TTS) and voice conversion (VC) algorithms. The LA set contains samples with coding and transmission variations, while the DF set contains compressed samples. The disclosed approach's better performance over both sets indicates that it is robust and generalized enough to handle the compression, codec, and transmission channel variability.

In the third experiment, the disclosed model's results on the ASVspoof2019-LA dataset were compared with the baseline approaches. The results are shown in Table 6. For this experiment, the disclosed approach outperforms the comparative approaches by attaining the minimum EER of 2.80%. However, the disclosed model attains the second-best min-tDCF on the ASV2019-LA dataset, compared to the baseline methods.

TABLE 6
Comparison with existing model utilizing
ASVspoof2019-LA dataset.

| | | | EER |
|---|---|---|---|
| Model | Test Dataset | min_tDCF | (%) |
| Baseline - LFCC-LCNN | ASV2019 - | 0.100 | 5.06 |
| Baseline - LFCC-GMM | LA - Eval | 0.212 | 8.09 |
| Baseline - CQCC-GMM | Set | 0.237 | 9.57 |
| Baseline - RawNet2 | | 0.129 | 4.66 |
| Automatic Speaker Verification- | | 0.1275 | 2.80 |
| Based System (202) Model | | | |

All comparisons shown in Tables 4 to 6 indicate that the approach shows significant performance improvement over the base models on all datasets. The baseline models (e.g., LFCC-LCNN, LFCC-GMM, CQCC-GMM, and RawNet2) exhibit various limitations that hinder their effectiveness in deepfake audio detection. Traditional methods (e.g., LFCC-LCNN and LFCC-GMM) rely on handcrafted features, which cannot capture the complex patterns present in deepfake speech. Similarly, the CQCC-GMM approach faces challenges in representing the diverse acoustic properties of deepfake audio. These feature-based methods often struggle with generalization across different datasets and lack the adaptability to learn complex representations directly from raw audio waveforms. While conventional RawNet2 is advanced by leveraging deep learning techniques, it still encounters issues such as vanishing gradients or dead neurons, leading to suboptimal performance and limited generalization. Further, conventional RawNet2 is not proficient in fully extracting deeper features from fake audio, and it lacks capturing intricate characteristics embedded in deceptive audio, which impacts the model's capacity to distinguish subtle distinctions indicative of deepfake speech. In contrast, the disclosed approach addresses these limitations of the traditional methods with the architecture that directly processes raw audio data with a high recall rate, enabling automatic learning of discriminative features and patterns without needing handcrafted features. Additionally, the disclosed model incorporates techniques (e.g., feature map scaling and improved activation functions) to enhance its ability to extract meaningful representations from raw audio, leading to reduced min-tDCF and EER. Furthermore, substituting simple convolution layers with transpose convolution layers in the residual block enables the model to preserve fine-grained temporal information crucial for capturing intricate patterns in deepfake audio data, addressing downsampling issues encountered by baseline models. Integrating the LogSoftmax activation function in the architecture further stabilizes numerical computations during training and inference, mitigating potential numerical instability problems traditional softmax activation functions face. By mitigating these challenges, the approach demonstrates enhanced robustness and efficacy in detecting deepfake audio compared to baseline models.

To perform a comparison of the disclosed model with the base and latest models over the VC samples, two experiments were performed. The VC samples comprise a challenging subset of the ASVSpoof-2019, and 21 LA datasets. The VC samples pose a challenge for detection due to their close resemblance to genuine speech, evolving sophistication in synthesis techniques, and retention of original speaker characteristics. The performance of the disclosed approach for detecting VC attacks is compared against the baseline approaches, namely LFCC-LCNN, LFCC-GMM, CQCC-GMM, and the baseline RawNet2.

For the VC samples of ASVspoof2019-LA dataset, the results of the disclosed approach are compared against the baseline methods, and the attained comparison is given in Table 7. Notably, the disclosed approach demonstrates significant improvement compared to all baseline approaches with the min-tDCF and EER of 0.4905 and 13.46%, respectively. These results highlight the robustness of the disclosed approach to the challenging voice conversion attacks in the domain of deepfake detection.

TABLE 7
Model evaluation results for VC attacks with
the latest works (ASV spoof 2019 LA).

| Method | min_tDCF | EER (%) |
|---|---|---|
| LFCC-LCNN | 0.5231 | 15.94 |
| LFCC-GMM | 0.6363 | 14.48 |
| CQCC-GMM | 0.7221 | 24.03 |
| Baseline RawNet-2 | 0.6638 | 18.34 |
| Automatic Speaker | 0.4905 | 13.46 |
| Verification-Based System | | |
| (202) Model | | |

In second experiment, the disclosed model's performance was checked for the VC samples from the ASVSpoof-2021 LA dataset and compared with the baseline approaches. The results of the comparison in terms of EER and min_tDCF are shown in Table 8. The results show that the disclosed approach achieves the best results over the base approaches in evaluation metrics with the EER and min-tDCF scores of 14.95% and 0.7308, respectively. These results signify that the disclosed approach is robust enough to tackle the codec variations induced in the ASVSpoof2021 LA dataset.

TABLE 8
Comparison with baselines on VC Samples (ASV spoof 2021 LA).

| Model | min-tDCF | EER (%) |
|---|---|---|
| LFCC-LCNN | 0.8483 | 23.02 |
| LFCC-GMM | 0.8608 | 22.15 |
| CQCC-GMM | 0.9444 | 32.15 |
| Baseline RawNet2 | 0.8876 | 19.71 |
| Automatic Speaker | 0.7308 | 14.95 |
| Verification-Based System | | |
| (202) Model | | |

The results reported in Tables 7 and 8 highlight the effectiveness of the disclosed model's method in enhancing the model's ability to detect voice conversion samples accurately, thereby contributing to the advancement of deepfake audio detection technology.

Two experiments were performed on the ASVSpoof-2019 and ASVSpoof-2021 datasets to compare the model's performance with the baseline models over the TTS samples. The TTS samples refer to samples generated using advanced synthesis techniques. These techniques closely mimic the acoustic properties of genuine human speech while embedding subtle artifacts that are difficult to detect. The disclosed model is evaluated against the TTS samples to ensure its reliability in real-world scenarios where sophisticated TTS systems are employed to create convincing fake audio.

In a first experiment, the disclosed model is compared against baseline models (e.g., LFCC-LCNN, LFCC-GMM, CQCC-GMM, and the baseline RawNet2) on ASVSpoof-2021 dataset. The results of the comparison are shown in Table 9. The results of the comparison show an improvement in both EER and min_tDCF and the superior performance of the disclosed model in distinguishing between genuine and spoofed TTS audio samples. The disclosed model captures intricate patterns within the audio data indicative of TTS spoofing attempts, which leads to more accurate detection. This experiment underscores the efficacy of the model modifications and indicates its robustness in handling compressed samples. The model outperforms the baseline models with enhanced capability to reliably detect TTS-based spoofing attacks, thereby contributing to the advancements of audio security technologies and the development of more robust defenses have been obtained against sophisticated deepfake audio attacks.

TABLE 9
Comparison with baselines on TTS Samples (ASV spoof 2021 LA)

| Model | EER (%) | Min-tDCF |
|---|---|---|
| LFCC-LCNN | 1.76 | 0.2014 |
| LFCC-GMM | 19.71 | 0.5384 |
| CQCC-GMM | 9.98 | 0.3826 |
| Baseline RawNet2 | 6.08 | 0.3230 |
| Automatic Speaker | 0.76 | 0.1826 |
| Verification-Based System | | |
| (202) Model | | |

In a second experiment, the TTS detection results on the ASVspoof2019 LA dataset was compared with the baseline models. The results of the comparison are shown in Table 10. The disclosed model attained comparable results with the RawNet2 model, whereas it achieved better performance compared to other baseline methods including LFCC-LCNN, LFCC-GMM, and CQCC-GMM, for the TTS attacks. Even though the disclosed model performed slightly lower than the baseline RawNet2, however, the results are still satisfactory. This slight performance gap emphasizes the need for further fine-tuning and possibly incorporating additional techniques (e.g., advanced feature engineering or ensemble learning) further to improve the robustness of the disclosed method.

TABLE 10
Comparison with baselines on TTS Samples (ASV spoof 2019 LA)

| Model | min-tDCF | EER (%) |
|---|---|---|
| LFCC-LCNN | 0.0738 | 1.128 |
| LFCC-GMM | 0.0765 | 2.816 |
| CQCC-GMM | 0.3016 | 10.061 |
| Baseline RawNet-2 | 0.0686 | 0.55 |
| Automatic Speaker | 0.0722 | 0.64 |
| Verification-Based System | | |
| (202) Model | | |

To evaluate an algorithm-wise Model Evaluation, an experiment was conducted to compare the performance of the disclosed model on the ASVspoof2019-LA and ASVSpoof2021-LA datasets algorithm-wise with the baseline approaches (LFCC-LCNN, LFCC-GMM, CQCC-GMM, and the baseline RawNet2). Comparing the algorithm-wise results of disclosed approach with the baseline methods is essential for validating the effectiveness of modifications. This experiment helps assess how the enhancements improve the framework's ability to detect deepfake audio across various attack techniques. The comparison of the disclosed model with the base models on the ASVSpoof2019-LA dataset is shown in Table 11. The disclosed approach significantly improved the performance for the most challenging A17 unknown voice conversion attack for the ASVspoof2019-LA dataset. Along with that, the model also shows superior performance in detecting other challenging VC attacks, including A18 and A19. Overall, the baseline LFCC-LCNN outperforms most of the TTS attacks, however, the disclosed model achieves outstanding results for VC attacks. Moreover, the disclosed model attains the lowest average EER across all attacks, compared to the baseline methods, however the average min-tDCF is comparable to that of LFCC-LCNN. The better performance metrics (specifically for VC attacks), such as lower EER and min-tDCF, compared to the baseline methods demonstrate the significance of our approach in enhancing the raw audio processing capabilities for deepfake detection.

TABLE 11
Algorithm-wise comparison of the disclosed approach with
the base models over the ASVSpoof2019-LA dataset.

| | Automatic | | | | | | | | | |
|---|---|---|---|---|---|---|---|---|---|---|
| | Speaker | | | | | | | | | |
| | Verification- | | | | | | | | CQCC- | |
| | Based System | | RawNet-2 | | LFCC-LCNN | | LFCC-GMM | | GMM | |
| | (202) Model | | (Baseline) | | (Baseline) | | (Baseline) | | (Baseline) | |
| | min- | | min- | | min- | | min- | | min- | |
| Attacks | tDCF | EER | tDCF | EER | tDCF | EER | tDCF | EER | tDCF | EER |
| A07 | 0.0538 | 0.22 | 0.0551 | 0.27 | 0.0237 | 0.71 | 0.0105 | 0.57 | 0.4980 | 15.44 |
| A08 | 0.1232 | 3.24 | 0.1231 | 3.05 | 0.0787 | 2.62 | 0.1654 | 4.07 | 0.0551 | 1.59 |
| A09 | 0.1831 | 0.11 | 0.1831 | 0.12 | 0.0300 | 0.11 | 0.0386 | 0.16 | 0.0020 | 0.02 |
| A10 | 0.0609 | 0.42 | 0.0634 | 0.53 | 0.0758 | 0.77 | 0.2099 | 6.75 | 0.5680 | 17.27 |
| A11 | 0.0588 | 0.38 | 0.0588 | 0.34 | 0.0219 | 0.65 | 0.0320 | 0.31 | 0.1935 | 5.71 |
| A12 | 0.0614 | 0.42 | 0.0629 | 0.51 | 0.0144 | 0.45 | 0.0990 | 3.57 | 0.0749 | 2.04 |
| A13 | 0.0519 | 0.11 | 0.0596 | 0.41 | 0.0194 | 0.63 | 0.0904 | 3.11 | 0.1291 | 3.97 |
| A14 | 0.0536 | 0.23 | 0.0536 | 0.23 | 0.0124 | 0.37 | 0.1210 | 4.47 | 0.2360 | 7.12 |
| A15 | 0.0560 | 0.27 | 0.0578 | 0.37 | 0.0958 | 0.38 | 0.1045 | 3.74 | 0.3156 | 9.89 |
| A16 | 0.0645 | 0.63 | 0.0700 | 0.90 | 0.0256 | 0.88 | 0.0810 | 0.42 | 0.1802 | 7.53 |
| A17 | 0.7333 | 7.33 | 0.8321 | 13.15 | 0.9074 | 17.44 | 0.8071 | 11.66 | 0.8546 | 18.82 |
| A18 | 0.8376 | 16.46 | 0.8929 | 19.59 | 0.9365 | 18.48 | 0.9287 | 17.97 | 0.9034 | 22.61 |
| A19 | 0.1295 | 1.37 | 0.1767 | 2.65 | 0.1618 | 5.84 | 0.2896 | 9.19 | 0.8902 | 29.65 |
| Average | 0.1898 | 2.40 | 0.2069 | 3.24 | 0.1849 | 3.79 | 0.2291 | 5.08 | 0.3770 | 10.90 |

To perform an algorithm-wise comparison of the model with the base models, an experiment is performed over the ASVSpoof2021-LA dataset. The results of the comparison are shown in Table 12. The performance is significantly improved for the unknown A17 (the most difficult attack for the baseline and top-performing challenge participants) and known A19 attacks, due to the strategic modifications. Overall, the superior performance for A17, A18, and A19, along with the average performance for TTS attacks (A07-A16), highlights the robustness of the disclosed model for challenging spoofing attacks and consistent effectiveness.

TABLE 12
Algorithm-wise comparison of the disclosed approach with the base models over the ASVSpoof2021-LA dataset.

| | Automatic | | | | | | | | | |
|---|---|---|---|---|---|---|---|---|---|---|
| | Speaker | | | | | | | | | |
| | Verification- | | | | | | | | | |
| | Based System | | RawNet-2 | | LFCC-LCNN | | LFCC-GMM | | CQCC-GMM | |
| | (202) Model | | (Baseline) | | (Baseline) | | (Baseline) | | (Baseline) | |
| Attacks | EER | min_tDCF | EER | min_tDCF | EER | min_tDCF | EER | min_tDCF | EER | min_tDCF |
| A07 | 1.87 | 0.1932 | 5.57 | 0.2838 | 0.80 | 0.1685 | 26.37 | 0.6822 | 9.17 | 0.3552 |
| A08 | 7.34 | 0.3271 | 8.87 | 0.3817 | 5.42 | 0.2728 | 6.39 | 0.2849 | 2.94 | 0.2227 |
| A09 | 2.44 | 0.4649 | 5.29 | 0.5678 | 0.41 | 0.3795 | 2.98 | 0.4190 | 1.43 | 0.4006 |
| A10 | 1.92 | 0.1950 | 5.34 | 0.2789 | 0.80 | 0.1696 | 30.35 | 0.7544 | 12.06 | 0.4195 |
| A11 | 2.53 | 0.2094 | 5.67 | 0.2843 | 0.78 | 0.1666 | 18.19 | 0.4942 | 8.81 | 0.3473 |
| A12 | 2.64 | 0.2213 | 5.98 | 0.3036 | 0.57 | 0.1695 | 20.30 | 0.5473 | 11.30 | 0.4010 |
| A13 | 1.31 | 0.1963 | 3.77 | 0.2628 | 0.66 | 0.1802 | 9.60 | 0.3712 | 10.19 | 0.3884 |
| A14 | 3.11 | 0.2169 | 6.19 | 0.2890 | 0.54 | 0.1570 | 17.92 | 0.5070 | 7.50 | 0.3058 |
| A15 | 2.55 | 0.2031 | 5.92 | 0.2807 | 0.41 | 0.1533 | 17.11 | 0.4900 | 6.38 | 0.2903 |
| A16 | 2.89 | 0.2113 | 5.60 | 0.2768 | 1.42 | 0.1727 | 22.51 | 0.6065 | 16.92 | 0.5077 |
| A17 | 15.92 | 0.9965 | 19.35 | 0.9999 | 23.62 | 0.9940 | 18.42 | 0.8679 | 29.02 | 0.9635 |
| A18 | 25.97 | 0.9997 | 27.34 | 1.0000 | 29.27 | 0.9351 | 16.34 | 0.8661 | 24.24 | 0.9107 |
| A19 | 4.96 | 0.4524 | 7.94 | 0.5448 | 14.73 | 0.5693 | 30.75 | 0.9314 | 43.20 | 0.9996 |
| Average | 5.8038 | 0.3759 | 8.6792 | 0.4426 | 6.11 | 0.3452 | 18.2485 | 0.6017 | 14.0892 | 0.5009 |

The results of both experiments (i.e., the evaluation conducted on both datasets (i.e., the ASVSpoof2019-LA dataset and the ASVSpoof2021-LA dataset)) show that the model is more proficient in locating real and fake audio and can effectively address key challenges encountered by the baseline models. The model captures complicated patterns in deepfake audio data, reducing EER and min-tDCF compared to the base models.

An ablation study experiment was conducted to analyze the impact of different architectural components on the disclosed model's performance. Two types of experiments are conducted. In the first experiment, the impact of individual architectural modifications is evaluated and attained results are reported in Table 13. In the first phase, only integrated Transpose Convolutions are integrated in the base RawNet2 model which improved performance by effectively mitigating the downsampling issue and enhancing feature resolution. In the next phase, we have checked the impact of adding the PRELU activation function which added learnable non-linearity, enabling the model to better adapt to varying input patterns. Lastly, we have analyzed the impact of using Log Softmax in the final classification layer which results in improving numerical stability and providing better-calibrated probability outputs. From the reported results in Table 13, it can be seen that, while each modification individually contributed to performance improvements, the combination of all three yielded the best results. This demonstrates that the joint impact of these modifications creates a synergistic effect by addressing different aspects of model optimization effectively.

TABLE 13
Performance comparison with step-by-step modification
added in RawNet2 on the ASVspoof2019-LA dataset.

| Model Modifications | | |
|---|---|---|
| Transpose | Log | Results |

| Conv | PReLU | Softmax | min-tDCF | EER |
|---|---|---|---|---|
| ✓ | | | 0.2228 | 7.04 |
| | ✓ | | 0.1672 | 4.92 |
| | | ✓ | 0.1866 | 5.56 |
| ✓ | ✓ | ✓ | 0.1275 | 2.80 |

In the second experiment, the results obtained are compared by the DeepRawNet approach against various configurations of RawNet2, including RawNet2 with ELU, ReLU, and Hardswish activation functions, RawNet2 with RNN, and LSTM layer (Table 14). These different architectural components are systematically varied, and their performance on the ASVspoof2019-LA dataset is evaluated to identify an effective architecture for deepfake audio detection. This ablation study provides valuable insights into each architectural component's contribution to the model's overall performance, helping to refine and optimize its design for enhanced performance. The results of the ablation study show the disclosed model consistently outperformed the other configurations across all evaluation metrics on the ASVspoof2019-LA dataset. While conducting the ablation study, certain limitations were observed with the other configurations of RawNet2. The variant utilizing the ELU activation function exhibited suboptimal performance due to its inability to effectively handle dead neurons and capture complex patterns in raw audio. Similarly, the configurations incorporating ReLU and Hardswish activation functions also faced challenges in effectively extracting discriminative features, leading to higher EER and min t-DCF values. Additionally, the variants incorporating RNN and LSTM layers showed limited improvement in performance, indicating that these recurrent architectures may not be well-suited for capturing long-range dependencies in raw audio waveforms. The disclosed approach performs better than all other RawNet approach configurations. Incorporation of the PRELU activation function increases the negative slope in Fixed Sinc filters, and the transpose convolution layer in the residual block exhibits superior performance in terms of EER and min-tDCF. This shows the effectiveness of the disclosed model's enhancements in improving the model's ability to capture discriminative features and patterns in raw audio waveforms. By achieving the best results with the model architecture, its superiority in deepfake audio detection compared to alternative configurations is demonstrated.

TABLE 14
Performance comparison with various configurations
of RawNet2 on the ASVspoof2019-LA dataset.

| Models | EER (%) | min-tDCF |
|---|---|---|
| RawNet2 - ELU | 5.57 | 0.1832 |
| RawNet2 - ReLU | 5.82 | 0.1841 |
| RawNet2 - Hardswish | 6.61 | 0.2072 |
| RawNet2 - RNN | 20.73 | 0.4049 |
| RawNet2 - LSTM | 7.95 | 0.2391 |
| Automatic Speaker Verification- | 2.80 | 0.1275 |
| Based System (202) Model | | |
| (train set) | | |

In an aspect, the automatic speaker verification-based system advances deepfake audio detection through enhancements of fixed Sinc filters, activation functions, transpose convolution layers, and LogSoftmax activation. The system exhibits improved adaptability and robustness in capturing complex patterns in raw audio and provides effective solution for speaker verification and spoofing detection tasks. Upon evaluating the performance of the automatic speaker verification-based system on ASVspoof2019-LA and ASVspoof2021-LA/DF datasets, improved results were obtained over the baseline conventional approaches. The automatic speaker verification-based system provides improved audio spoof detection performance and better recognizes the VC samples which are more complex to detect. The automatic speaker verification-based system helps recognize audio deepfakes, offering improved accuracy, robustness, and generalization across diverse datasets and attack types. It can effectively handle the codec, transmission variations, and compressed samples.

The automatic speaker verification-based system prevents dead neurons by increasing the negative slope in the Fixed Sinc filters. Intricate patterns are captured in raw audio. A more dynamic and effective dynamic representation of features is provided across the entire input space.

The automatic speaker verification-based system increases adaptability by enabling dynamic response to various input distributions by activating PRELU over the LeakyReLU. This contributes to more effective learning and improved feature extraction capabilities.

Substituting the simple convolution layer with a transpose convolution layer in the residual block helps overcome the downsampling issues. This modification preserves fine-grained temporal information, crucial for capturing detailed patterns in raw audio, and improves the overall performance.

The addition of the LogSoftmax activation function improves computation stability and efficiency. This facilitates more stable and numerically efficient training and inference processes in tasks (e.g., speaker verification and speech analysis).

The automatic speaker verification-based system performs better in detecting VC samples within the ASVSpoof-2019 LA dataset through strategic enhancements (i.e., optimized filter slopes and improved activation functions).

The cumulative effect of the adaptations (i.e., increasing the negative slope in the Fixed Sinc filters, the PRELU activation in the residual blocks over Leaky ReLU in the baseline, substituting the simple convolution layer with the transpose convolution layer in the residual block and incorporating the LogSoftmax activation function) empowers the automatic speaker verification-based system over conventional speaker verification with enhanced generalization ability. This helps recognize a variety of voice spoofing attacks on different corpora over the base model.

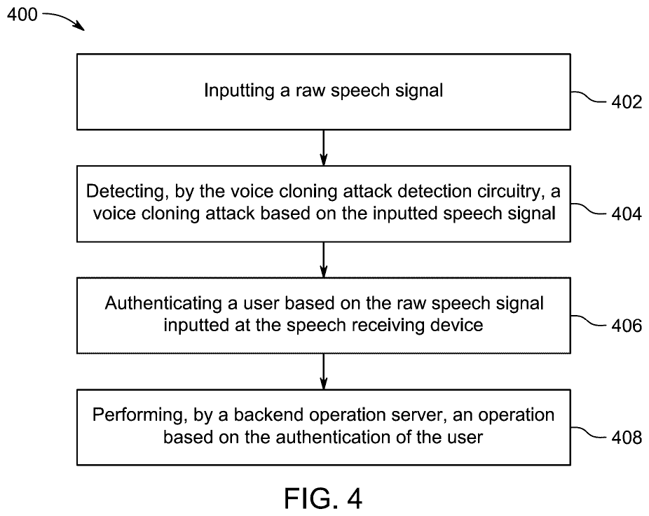

FIG. 4 illustrates a flowchart of an automatic speaker verification method 400, according to certain embodiments. The method 400 includes a series of steps. These steps are only illustrative, and other alternatives may be considered where one or more steps are added, one or more steps are removed, or one or more steps are provided in a different sequence without departing from the scope of the present disclosure.

At step 402, method 400 includes inputting a raw speech signal. The speech receiving device inputs the raw speech signal. In an aspect, the speech receiving device is a mobile device or a smart speaker.

In one aspect, the raw speech signal includes a signal generated by speech synthesis or voice conversion.

At step 404, the method 400 includes detecting, by the voice cloning attack detection circuitry, a voice cloning attack based on the inputted speech signal.

In an aspect, the voice cloning attack detection circuitry includes a deep learning framework to detect whether the inputted speech signal is real or fake. The method 400 includes extracting, by the convolutional block, features from the speech signal. In an aspect, the features from the speech signal comprise, but is not limited to, pitch, modulation, pace, spectral features, acoustic features, etc.

The method 400 includes increasing a negative slope in fixed sinc filters in multiple interconnected residual blocks to prevent dead neurons. In an aspect, the negative slope is increased in fixed sinc filters in the multiple interconnected residual blocks. The neurons are prevented from becoming entirely inactive, facilitating the flow of gradients during backpropagation and enabling learning from all data points, including those with negative input values. More diverse features and representations are captured. This enhances the model's expressiveness. Further, the increased negative slope reduces gradient problem and benefits deep neural networks. In an operative aspect, a significant portion of the input values can be negative, the increased negative slope allows for more effective learning and improving the overall training dynamics. The method includes aggregating, in a gated recurrent unit (GRU), a frame-level representation from a last of the residual blocks into an utterance-level representation. In an aspect, the GRU comprises 1024 hidden nodes to consolidate frame-level representations into a unified utterance-level representation. An additional fully connected layer follows the GRU output before reaching the output layer.

The method 400 includes preserving, by the transpose convolution layer in the residual blocks, fine-grained temporal information. In an aspect, the transpose convolution layers in the residual block preserve fine-grained temporal information which is used for capturing intricate patterns in deepfake audio data and temporal dependencies. The transpose convolution layers reduces downsampling issues.

The method 400 further includes enhancing the extracting of features by the PreLU activation function in each of the residual blocks. In an aspect, the PRELU activation function in each of the residual blocks presents a learnable negative slope to mitigate the risk of dead neurons. The increased adaptability of PRELU enabled by its learnable parameters ensures dynamic responses to various input distributions, promoting more effective learning and feature extraction.

The method 400 further includes transforming, by the LogSoftmax activation function, raw model outputs into logarithmic probabilities of real or fake audio data. In an aspect, the LogSoftmax activation function is added in the final layer of the deep learning network. LogSoftmax transforms the raw model outputs into logarithmic probabilities, facilitating more stable and numerically efficient computations during training and inference. The LogSoftmax activation function helps in recognizing the real and fake audio.

At step 406, the method 400 includes authenticating a user based on the raw speech signal inputted at the speech receiving device. In an aspect, the user is authenticated based on the raw speech signal inputted at the speech receiving device.

At step 408, the method 400 includes performing, by a backend operation server, an operation based on the authentication of the user. In an aspect, the operation comprises performing a financial operation that requires secure operation. In an aspect, the operation further comprises controlling a household appliance. In an aspect, the operation further comprises performing an operation to access to phone operations.

The first embodiment is illustrated with respect to FIGS. 2A-2B. The first embodiment describes the automatic speaker verification-based system 202 with detection of a voice cloning attack. The system 202 comprises a speech receiving device 204 for inputting a raw speech signal, a voice cloning attack detection circuitry 210 configured to detect the voice cloning attack based on the raw speech signal inputted at the speech receiving device 204, an authentication component 206 for authenticating a user based on the raw speech signal inputted at the speech receiving device 204, and a backend operation server 208 that performs an operation based on the authentication of the user. The voice cloning attack detection circuitry 210 includes a deep learning framework 220 having a convolutional block 212 configured to extract features from the speech signal, a plurality of interconnected residual blocks 214, and a gated recurrent unit (GRU) 216. A negative slope in fixed sinc filters in the residual blocks 214 is increased to prevent dead neurons. The GRU 216 is configured to aggregate a frame-level representation from a last of the residual blocks 214 into an utterance-level representation.

In an aspect, the voice cloning attack detection circuitry 210 includes a transpose convolution layer 232 in the residual blocks 214 for preserving fine-grained temporal information.

In an aspect, the voice cloning attack detection circuitry 210 includes a PRELU activation function 228 in each of the residual blocks 214.

In an aspect, the voice cloning attack detection circuitry 210 includes a LogSoftmax activation function 236 in a final layer of the deep learning framework 220 for recognizing real and fake audio, and the LogSoftmax activation function 236 transforms raw model outputs into logarithmic probabilities of real or fake audio data.

In an aspect, the speech receiving device 204 is a mobile device. The backend operation is access to phone operations.

In an aspect, the speech receiving device 204 is a smart speaker having voice assistant circuitry. The backend operation is a financial operation that requires secure operation.

In an aspect, the speech receiving device 204 is a smart speaker having voice assistant circuitry, wherein the backend operation is control of a household appliance.

In an aspect, the voice cloning attack detection circuitry 210 detects that the speech signal is generated by speech synthesis.

In an aspect, the voice cloning attack detection circuitry 210 detects that the speech signal is generated by voice conversion.

In an aspect, the speech receiving device 204 inputs a control command as the raw speech signal to request control of the household appliance.

The second embodiment is illustrated with FIG. 4. The second embodiment describes an automatic speaker verification method. The method comprises inputting a raw speech signal and detecting, by a voice cloning attack detection circuitry 210, a voice cloning attack based on the inputted speech signal. The method further comprises authenticating a user based on the raw speech signal inputted at the speech receiving device 204 and performing, by a backend operation server 208, an operation based on the authentication of the user. The voice cloning attack detection circuitry 210 includes a deep learning framework 220. The detecting includes extracting, by a convolutional block 212, features from the speech signal, increasing a negative slope in fixed sinc filters in multiple interconnected residual blocks 214 to prevent dead neurons, and aggregating, in a gated recurrent unit (GRU) 216, a frame-level representation from a last of the residual blocks into an utterance-level representation.

In an aspect, the method further comprises preserving, by a transpose convolution layer 232 in the residual blocks 214, fine-grained temporal information.

In an aspect, the method further comprises enhancing the extracting of features by a PRELU activation function 228 in each of the residual blocks 214.

In an aspect, the method further comprises transforming, by a LogSoftmax activation function 236, raw model outputs into logarithmic probabilities of real or fake audio data.

In an aspect, the method further comprises the performing an operation further comprises performing an operation to access to phone operations.

In an aspect, the method further comprises the performing an operation further comprises performing a financial operation that requires secure operation.

In an aspect, the method further comprises the performing an operation further comprises controlling a household appliance.

In an aspect, the inputting a raw speech signal includes a speech signal that is generated by speech synthesis.

In an aspect, the inputting a raw speech signal includes a speech signal that is generated by voice conversion.

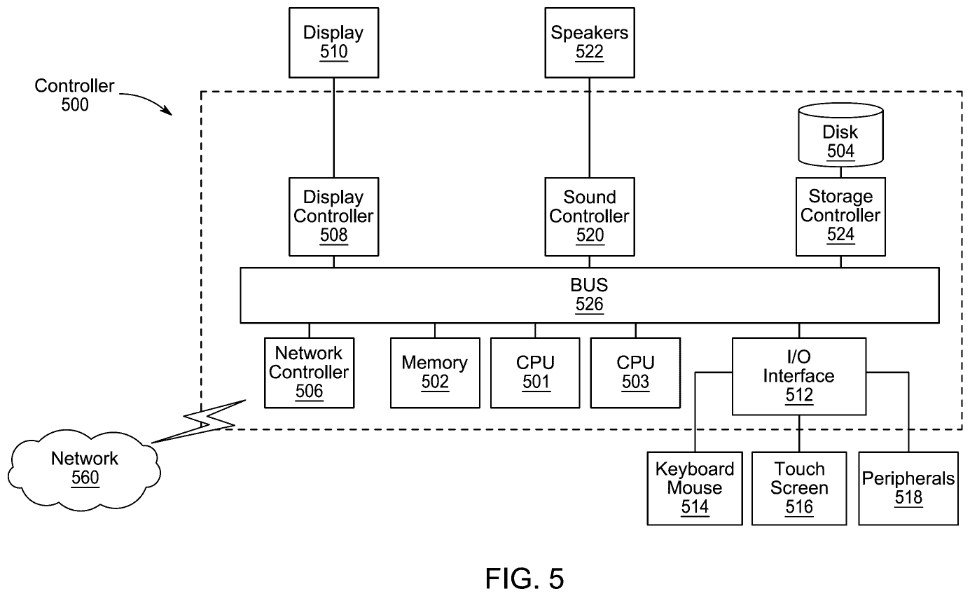

Next, further details of the hardware description of the computing environment of FIG. 2A according to exemplary embodiments is described with reference to FIG. 5.

FIG. 5 shows an illustration of a non-limiting example of details of computing hardware, according to certain embodiments, for performing the functions of the exemplary embodiments.

In FIG. 5, a controller 500 is described is representative of the system 202 of FIG. 2A in which the controller is a computing device which includes a CPU 501 which performs the processes described above/below. The process data and instructions may be stored in memory 502. These processes and instructions may also be stored on a storage medium disk 504 such as a hard drive (HDD) or portable storage medium or may be stored remotely.

Further, the present disclosure is not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the computing device communicates, such as a server or computer.

Further, the present disclosure may be provided as a utility application, background daemon, or component of an operating system, or combination thereof, executing in conjunction with CPU 501, 503 and an operating system such as Microsoft Windows 7, Microsoft Windows 10, UNIX, LINUX, Apple MAC-OS and other systems known to those skilled in the art.

The hardware elements in order to achieve the computing device may be realized by various circuitry elements, known to those skilled in the art. For example, CPU 501 or CPU 503 may be a Xenon or Core processor from Intel of America or an Opteron processor from AMD of America, or may be other processor types that would be recognized by one of ordinary skill in the art. Alternatively, the CPU 501, 503 may be implemented on an FPGA, ASIC, PLD or using discrete logic circuits, as one of ordinary skill in the art would recognize. Further, CPU 501, 503 may be implemented as multiple processors cooperatively working in parallel to perform the instructions of the inventive processes described above.

The computing device in FIG. 5 also includes a network controller 506, such as an Intel Ethernet PRO network interface card from Intel Corporation of America, for interfacing with network 560. As can be appreciated, the network 560 can be a public network, such as the Internet, or a private network such as an LAN or WAN network, or any combination thereof and can also include PSTN or ISDN sub-networks. The network 560 can also be wired, such as an Ethernet network, or can be wireless such as a cellular network including EDGE, 3G, 4G, and 5G wireless cellular systems. The wireless network can also be WiFi, Bluetooth, or any other wireless form of communication that is known.

The computing device further includes a display controller 508, such as a NVIDIA GeForce GTX or Quadro graphics adaptor from NVIDIA Corporation of America for interfacing with display 510, such as a Hewlett Packard HPL2445w LCD monitor. A general purpose I/O interface 512 interfaces with a keyboard and/or mouse 514 as well as a touch screen panel 516 on or separate from display 510. General purpose I/O interface also connects to a variety of peripherals 518 including printers and scanners, such as an OfficeJet or DeskJet from Hewlett Packard.

A sound controller 520 is also provided in the computing device such as Sound Blaster X-Fi Titanium from Creative, to interface with speakers/microphone 522 thereby providing sounds and/or music.

The general-purpose storage controller 524 connects the storage medium disk 504 with communication bus 526, which may be an ISA, EISA, VESA, PCI, or similar, for interconnecting all of the components of the computing device. A description of the general features and functionality of the display 510, keyboard and/or mouse 514, as well as the display controller 508, storage controller 524, network controller 506, sound controller 520, and general purpose I/O interface 512 is omitted herein for brevity as these features are known.

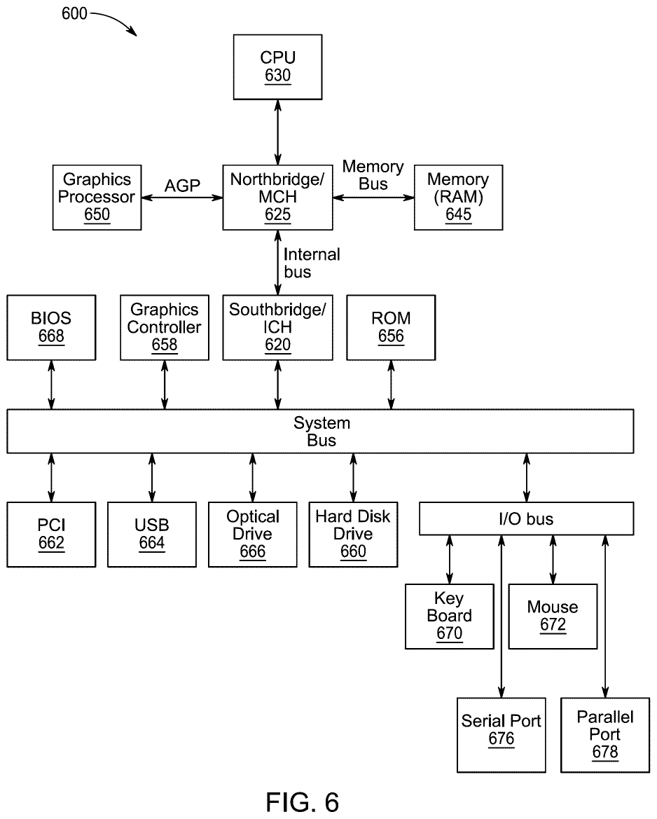

The exemplary circuit elements described in the context of the present disclosure may be replaced with other elements and structured differently than the examples provided herein. Moreover, circuitry configured to perform features described herein may be implemented in multiple circuit units (e.g., chips), or the features may be combined in circuitry on a single chipset, as shown on FIG. 6.

FIG. 6 shows a schematic diagram of a data processing system, according to certain embodiments, for performing the functions of the exemplary embodiments. The data processing system is an example of a computer in which code or instructions implementing the processes of the illustrative embodiments may be located.

In FIG. 6, data processing system 600 employs a hub architecture including a north bridge and memory controller hub (NB/MCH) 625 and a south bridge and input/output (I/O) controller hub (SB/ICH) 620. The central processing unit (CPU) 630 is connected to NB/MCH 625. The NB/MCH 625 also connects to the memory 645 via a memory bus, and connects to the graphics processor 650 via an accelerated graphics port (AGP). The NB/MCH 625 also connects to the SB/ICH 620 via an internal bus (e.g., a unified media interface or a direct media interface). The CPU Processing unit 630 may contain one or more processors and even may be implemented using one or more heterogeneous processor systems.

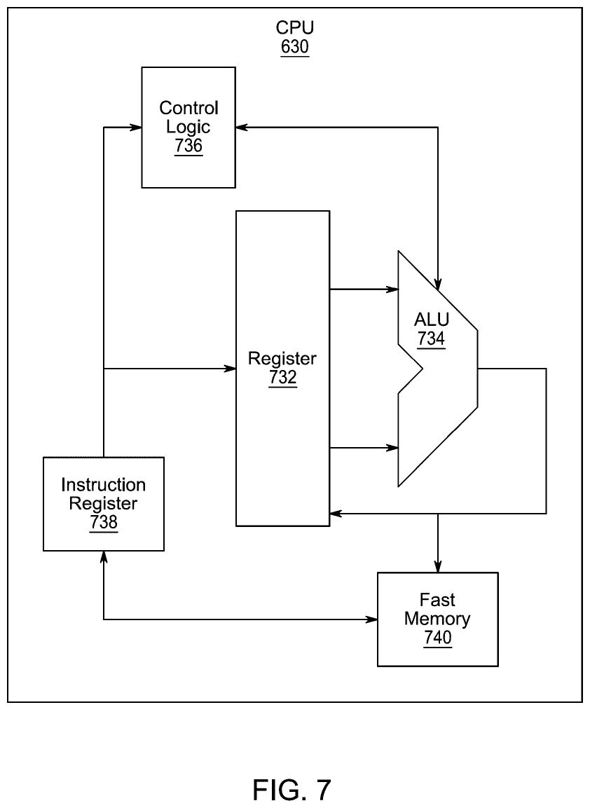

For example, FIG. 7 shows one implementation of CPU 630. In one implementation, the instruction register 738 retrieves instructions from the fast memory 740. At least part of these instructions are fetched from the instruction register 738 by the control logic 736 and interpreted according to the instruction set architecture of the CPU 630. Part of the instructions can also be directed to the register 732. In one implementation the instructions are decoded according to a hardwired method, and in another implementation the instructions are decoded according to a microprogram that translates instructions into sets of CPU configuration signals that are applied sequentially over multiple clock pulses. After fetching and decoding the instructions, the instructions are executed using the arithmetic logic unit (ALU) 734 that loads values from the register 732 and performs logical and mathematical operations on the loaded values according to the instructions. The results from these operations can be feedback into the register and/or stored in the fast memory 740. According to certain implementations, the instruction set architecture of the CPU 630 can use a reduced instruction set architecture, a complex instruction set architecture, a vector processor architecture, a very large instruction word architecture. Furthermore, the CPU 630 can be based on the Von Neuman model or the Harvard model. The CPU 630 can be a digital signal processor, an FPGA, an ASIC, a PLA, a PLD, or a CPLD. Further, the CPU 630 can be an x86 processor by Intel or by AMD; an ARM processor, a Power architecture processor by, e.g., IBM; a SPARC architecture processor by Sun Microsystems or by Oracle; or other known CPU architecture.

Referring again to FIG. 6, the data processing system 600 can include that the SB/ICH 620 is coupled through a system bus to an I/O Bus, a read only memory (ROM) 656, universal serial bus (USB) port 664, a flash binary input/output system (BIOS) 668, and a graphics controller 658. PCI/PCIe devices can also be coupled to SB/ICH 620 through a PCI bus 662.

The PCI devices may include, for example, Ethernet adapters, add-in cards, and PC cards for notebook computers. The Hard disk drive 660 and CD-ROM 656 can use, for example, an integrated drive electronics (IDE) or serial advanced technology attachment (SATA) interface. In one implementation the I/O bus can include a super I/O (SIO) device.

Further, the hard disk drive (HDD) 660 and optical drive 666 can also be coupled to the SB/ICH 620 through a system bus. In one implementation, a keyboard 670, a mouse 672, a parallel port 678, and a serial port 676 can be connected to the system bus through the I/O bus. Other peripherals and devices that can be connected to the SB/ICH 620 using a mass storage controller such as SATA or PATA, an Ethernet port, an ISA bus, a LPC bridge, SMBus, a DMA controller, and an Audio Codec.

Moreover, the present disclosure is not limited to the specific circuit elements described herein, nor is the present disclosure limited to the specific sizing and classification of these elements. For example, the skilled artisan will appreciate that the circuitry described herein may be adapted based on changes on battery sizing and chemistry or based on the requirements of the intended back-up load to be powered.

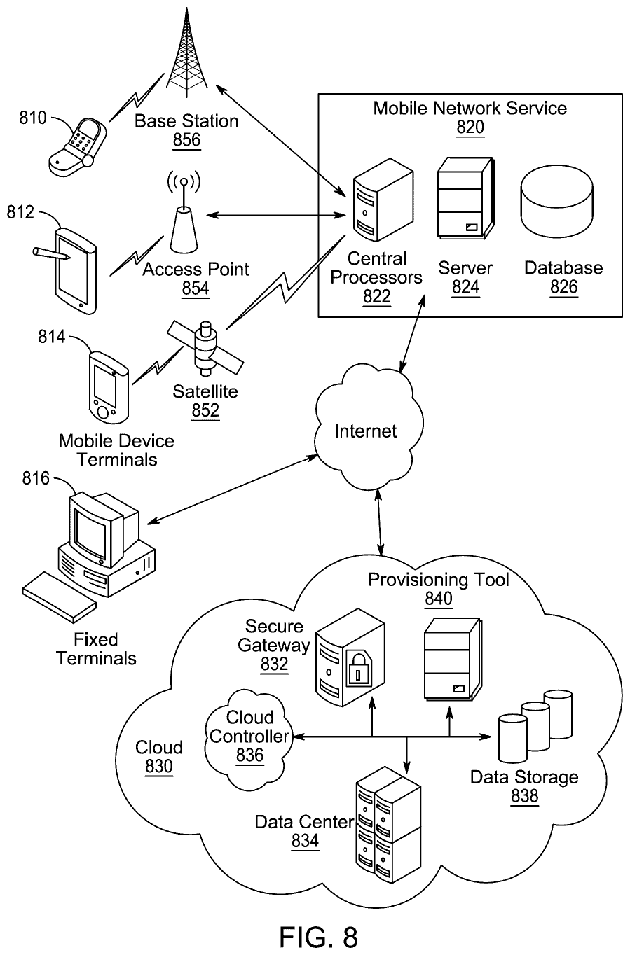

The functions and features described herein may also be executed by various distributed components of a system. For example, one or more processors may execute these system functions, wherein the processors are distributed across multiple components communicating in a network. The distributed components may include one or more client and server machines, which may share processing, as shown by FIG. 8, in addition to various human interface and communication devices (e.g., display monitors, smart phones, tablets, personal digital assistants (PDAs)). More specifically, FIG. 8 illustrates client devices including a smart phone 811, a tablet 812, a mobile device terminal 814 and fixed terminals 816. These client devices may be commutatively coupled with a mobile network service 820 via a base station 856, an access point 854, a satellite 852 or via an internet connection. The mobile network service 820 may comprise central processors 822, a server 824 and a database 826. The fixed terminals 816 and the mobile network service 820 may be commutatively coupled via an internet connection to functions in cloud 830 that may comprise a security gateway 832, a data center 834, a cloud controller 836, a data storage 838 and a provisioning tool 840. The network may be a private network, such as the LAN or the WAN, or may be the public network, such as the Internet. Input to the system may be received via direct user input and received remotely either in real-time or as a batch process. Additionally, some implementations may be performed on modules or hardware not identical to those described. Accordingly, other implementations are within the scope that may be disclosed.

The above-described hardware description is a non-limiting example of corresponding structure for performing the functionality described herein.

Numerous modifications and variations of the present disclosure are possible in light of the above teachings. It is therefore to be understood that the invention may be practiced otherwise than as specifically described herein.

1. An automatic speaker verification-based system with detection of a voice cloning attack, comprising:
a speech receiving device for inputting a raw speech signal;
a voice cloning attack detection circuitry configured to detect the voice cloning attack based on the raw speech signal inputted at the speech receiving device;
an authentication component for authenticating a user based on the raw speech signal inputted at the speech receiving device; and
a backend operation server that performs an operation based on the authentication of the user,
wherein the voice cloning attack detection circuitry includes a deep learning framework having:
a convolutional block configured to extract features from the speech signal,
a plurality of interconnected residual blocks, wherein a negative slope in fixed sinc filters in the residual blocks is increased to prevent dead neurons, and
a gated recurrent unit (GRU) configured to aggregate a frame-level representation from a last of the residual blocks into an utterance-level representation.

2. The system of claim 1, wherein the voice cloning attack detection circuitry includes a transpose convolution layer in the residual blocks for preserving fine-grained temporal information.

3. The system of claim 1, wherein the voice cloning attack detection circuitry includes a PreLU activation function in each of the residual blocks.

4. The system of claim 1, wherein the voice cloning attack detection circuitry includes a LogSoftmax activation function in a final layer of the deep learning framework for recognizing real and fake audio, and
wherein, the LogSoftmax activation function transforms raw model outputs into logarithmic probabilities of real or fake audio data.

5. The system of claim 1, wherein the speech receiving device is a mobile device, wherein the backend operation is access to phone operations.

6. The system of claim 1, wherein the speech receiving device is a smart speaker having voice assistant circuitry, wherein the backend operation is a financial operation that requires secure operation.

7. The system of claim 1, wherein the speech receiving device is a smart speaker having voice assistant circuitry, wherein the backend operation is control of a household appliance.

8. The system of claim 1, wherein the voice cloning attack detection circuitry detects that the speech signal is generated by speech synthesis.

9. The system of claim 1, wherein the voice cloning attack detection circuitry detects that the speech signal is generated by voice conversion.

10. The system of claim 7, wherein the speech receiving device inputs a control command as the raw speech signal to request control of the household appliance.

11. An automatic speaker verification method, comprising:
inputting a raw speech signal;
detecting, by a voice cloning attack detection circuitry, a voice cloning attack based on the inputted speech signal;
authenticating a user based on the raw speech signal inputted at the speech receiving device; and
performing, by a backend operation server, an operation based on the authentication of the user,
wherein the voice cloning attack detection circuitry includes a deep learning framework,
wherein the detecting includes
extracting, by a convolutional block, features from the speech signal;
increasing a negative slope in fixed sinc filters in multiple interconnected residual blocks to prevent dead neurons; and
aggregating, in a gated recurrent unit (GRU), a frame-level representation from a last of the residual blocks into an utterance-level representation.

12. The method of claim 11, further comprising preserving, by a transpose convolution layer in the residual blocks, fine-grained temporal information.

13. The method of claim 11, further comprising enhancing the extracting of features by a PreLU activation function in each of the residual blocks.

14. The method of claim 11, further comprising transforming, by a LogSoftmax activation function, raw model outputs into logarithmic probabilities of real or fake audio data.

15. The method of claim 11, wherein the performing an operation further comprises performing an operation to access to phone operations.

16. The method of claim 11, wherein the performing an operation further comprises performing a financial operation that requires secure operation.

17. The method of claim 11, wherein the performing an operation further comprises controlling a household appliance.

18. The method of claim 11, wherein the inputting a raw speech signal includes a speech signal that is generated by speech synthesis.

19. The method of claim 11, wherein the inputting a raw speech signal includes a speech signal that is generated by voice conversion.

20. A non-transitory computer-readable storage medium including computer executable instructions, wherein the instructions, when executed by a computer, cause the computer to perform a method of automatic speaker verification, the method comprising:
inputting a raw speech signal;
detecting, by a voice cloning attack detection circuitry, a voice cloning attack based on the inputted speech signal;
authenticating a user based on the raw speech signal inputted at the speech receiving device; and
performing, by a backend operation server, an operation based on the authentication of the user,
wherein the detecting includes
extracting, by a convolutional block, features from the speech signal;
increasing a negative slope in fixed sinc filters in multiple interconnected residual blocks to prevent dead neurons; and
aggregating, in a gated recurrent unit (GRU), a frame-level representation from a last of the residual blocks into an utterance-level representation.
